(19) United States
(12) Patent Application Publication
(10) Pub. No.: US 2024/0130383 A1
(43) Pub. Date: Apr. 25, 2024

(54) COATING COMPOSITIONS INCLUDING ALKYL ESTERS

(71) Applicant: Apeel Technology, Inc., Goleta, CA (US)

(72) Inventors: Gigi Lin, Goleta, CA (US); Stanley Zhang, Goleta, CA (US); Ronald C. Bakus, Goleta, CA (US)

(21) Appl. No.: 18/371,767

(22) Filed: Sep. 22, 2023

Related U.S. Application Data
(60) Provisional application No. 63/408,964, filed on Sep. 22, 2022.

(51) Int. Cl. A23B 7/154; A23B 7/16

(52) U.S. Cl. CPC A23B 7/154; A23B 7/16

(57) ABSTRACT

The present disclosure relates to compositions including monoglycerides and alkyl esters of fatty acids. An exemplary embodiment includes about 15 wt % to about 99 wt % of one or more monoglycerides of a C₄-C₂₈ fatty acid, and about 1 wt % to about 75 wt % of one or more alkyl esters of a C₈-C₂₀ fatty acid.

### CROSS-REFERENCE TO RELATED APPLICATION

This application claims the benefit of priority to U.S. Application No. 63/408,964, filed on Sep. 22, 2022, the contents of which are hereby incorporated by reference in its entirety.

### TECHNICAL FIELD

The present disclosure relates to coatings for agricultural products.

### BACKGROUND

Common agricultural products are susceptible to degradation and decomposition (i.e., spoilage) when exposed to the environment. Such agricultural products can include, for example, eggs, fruits, vegetables, produce, seeds, nuts, flowers, and/or whole plants (including their processed and semi-processed forms). Non-agricultural products (e.g., vitamins, candy, etc.) are also vulnerable to degradation when exposed to the ambient environment. The degradation of the agricultural products can occur via abiotic means as a result of evaporative moisture loss from an external surface of the agricultural products to the atmosphere, and/or oxidation by oxygen that diffuses into the agricultural products from the environment, and/or mechanical damage to the surface, and/or light-induced degradation (i.e., photodegradation). Furthermore, biotic stressors such as, for example, bacteria, fungi, viruses, and/or pests can also infest and decompose the agricultural products.

Conventional approaches to preventing degradation, maintaining quality, and increasing the life of agricultural products include refrigeration and/or special packaging. Refrigeration requires capital-intensive equipment, demands constant energy expenditure, can cause damage or quality loss to the product if not carefully controlled, and must be actively managed. Also, the benefits of refrigeration are lost upon interruption of a temperature-controlled supply chain. Special packaging can also require expensive equipment, consume packaging material, increase transportation costs, and require active management. Despite the benefits that can be afforded by refrigeration and special packaging, the handling and transportation of the agricultural products can cause surface abrasion or bruising that is aesthetically displeasing to the consumer and can serve as a point of ingress for bacteria and fungi. Moreover, the expenses associated with such approaches can add to the cost of the agricultural product.

### SUMMARY

Provided herein is a composition including one or more monoglycerides of a C₄-C₂₈ fatty acid, present in a total amount of about 15 wt % to about 99 wt % of the composition, and one or more alkyl esters of a C₈-C₂₀ fatty acid, present in a total amount of about 1 wt % to about 75 wt % of the composition.

Also provided herein is a composition including one or more monoglycerides of a C₄-C₂₈ fatty acid, and one or more alkyl esters of a C₈-C₂₀ fatty acid. A ratio of a total number of moles of the one or more monoglycerides to a total number of moles of the one or more alkyl esters is about 100:1 to about 1:5.

Also provided herein is a mixture of a composition described herein and a solvent.

Also provided herein is a coated agricultural product including an agricultural product and a layer disposed on a surface of the agricultural product, the layer including a composition described herein.

Also provided herein is a method of coating an agricultural product, the method including contacting a surface of the agricultural product with a mixture including a coating agent and a solvent, and removing at least a portion of the solvent to form a coating on the surface of the agricultural product. The coating agent includes one or more monoglycerides of a C₄-C₂₈ fatty acid, and one or more alkyl esters of a C₈-C₂₀ fatty acid. A ratio of a total number of moles of the one or more monoglycerides to a total number of moles of the one or more alkyl esters is about 100:1 to about 1:5.

Also provided herein is a method of coating an agricultural product, the method including contacting a surface of the agricultural product with a mixture described herein, and removing at least a portion of the solvent to form a coating on the surface of the agricultural product.

Although the disclosed inventive concepts include those defined in the attached claims, it should be understood that the inventive concepts can also be defined in accordance with the following embodiments.

In addition to the embodiments of the attached claims and the embodiments described above, the following numbered embodiments are also innovative.

Embodiment 1 is a composition comprising:
one or more monoglycerides of a C₄-C₂₈ fatty acid, present in a total amount of about 15 wt % to about 99 wt % of the composition; and
one or more alkyl esters of a C₈-C₂₀ fatty acid, present in a total amount of about 1 wt % to about 75 wt % of the composition.

Embodiment 2 is the composition of embodiment 1, wherein:
the one or more monoglycerides are present in a total amount of about 70 wt % to about 99 wt % of the composition; and
the one or more alkyl esters are present in a total amount of about 1 wt % to about 15 wt % of the composition.

Embodiment 3 is the composition of embodiment 2, wherein the one or more alkyl esters are present in a total amount of about 1 wt % to about 10 wt % of the composition.

Embodiment 4 is the composition of embodiment 1, wherein:
the one or more monoglycerides are present in a total amount of about 15 wt % to about 85 wt % of the composition; and
the one or more alkyl esters are present in a total amount of about 15 wt % to about 75 wt % of the composition.

Embodiment 5 is the composition of any one of embodiments 1-4, wherein the one or more monoglycerides and the one or more alkyl esters make up about 70 wt % to about 98 wt % of the composition.

Embodiment 6 is the composition of any of embodiments 1-5, further comprising one or more salts of a C₄-C₂₈ fatty acid, present in a total amount of 0.1 wt % to about 30 wt % of the composition.

Embodiment 7 is the composition of embodiment 6, wherein the one or more salts are present in a total amount of about 1 wt % to about 20 wt % of the composition.

Embodiment 8 is the composition of embodiment 6, wherein the one or more salts are present in a total amount of about 1 wt % to about 10 wt % of the composition.

Embodiment 9 is a composition comprising:
one or more monoglycerides of a C₄-C₂₈ fatty acid; and
one or more alkyl esters of a C₈-C₂₀ fatty acid;
   wherein a ratio of a total number of moles of the one or more monoglycerides to a total number of moles of the one or more alkyl esters is about 100:1 to about 1:5.

Embodiment 10 is the composition of embodiment 9, wherein the ratio of the total number of moles of the one or more monoglycerides to the total number of moles of the one or more alkyl esters is about 50:1 to about 6:1.

Embodiment 11 is the composition of embodiment 9, wherein the ratio of the total number of moles of the one or more monoglycerides to the total number of moles of the one or more alkyl esters is about 3:1 to about 1:3.

Embodiment 12 is the composition of any of embodiments 9-11, wherein the one or more monoglycerides and the one or more alkyl esters make up about 70 wt % to about 98 wt % of the composition.

Embodiment 13 is the composition of any of embodiments 9-12, further comprising one or more salts of a C₄-C₂₈ fatty acid.

Embodiment 14 is the composition of embodiment 13, wherein a ratio of a total number of moles of the one or more monoglycerides and the one or more alkyl esters to a total number of moles of the one or more salts is about 100:1 to about 4:1.

Embodiment 15 is the composition of embodiment 13, wherein a ratio of a total number of moles of the one or more monoglycerides and the one or more alkyl esters to a total number of moles of the one or more salts is about 50:1 to about 6:1.

Embodiment 16 is the composition of any of embodiment 13-15, wherein the one or more monoglycerides, the one or more alkyl esters, and the one or more salts make up at least 80 wt % of the composition.

Embodiment 17 is the composition of any of embodiments 1-16, wherein the one or more alkyl esters each independently comprise a C₁-C₅ alkyl ester.

Embodiment 18 is the composition of any of embodiments 1-16, wherein the one or more alkyl esters each independently comprise a methyl ester, an ethyl ester, a propyl ester, an isopropyl ester, a tert-butyl ester, or an iso-amyl ester.

Embodiment 19 is the composition of any of embodiments 1-16, wherein at least one of the alkyl esters comprises an ethyl ester or a propyl ester.

Embodiment 20 is the composition of any of embodiments 1-16, wherein each of the one or more alkyl esters independently comprises a compound of Formula III:

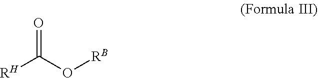

wherein:
   R^{B} is C₁-C₈ alkyl; and
   R^{H} is a C₇-C₁₉ side chain.

Embodiment 21 is the composition of embodiment 20, wherein R^{B} is C₁-C₅ alkyl.

Embodiment 22 is the composition of embodiment 20, wherein R^{B} is C₂ alkyl or C₃ alkyl.

Embodiment 23 is the composition of any of embodiments 20-22, wherein R^{H} is a saturated, unsubstituted side chain.

Embodiment 24 is the composition of any of embodiments 20-23, wherein R^{H} is a C₁₁-C₁₇ side chain.

Embodiment 25 is the composition of any of embodiments 1-16, wherein each of the one or more alkyl esters independently comprises a compound of Formula IIIA:

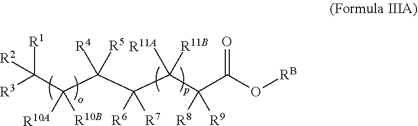

wherein:
   R^{B} is C₁-C₈ alkyl;
   R¹, R², R³, R⁴, R⁵, R⁶, R⁷, R⁸, and R⁹ are each independently selected from H, OH, C₁-C₆ alkyl, C₂-C₆ alkenyl, and C₁-C₆ alkoxy;
   each occurrence of R^{10A}, R^{10B}, R^{11A}, and R^{11B} is independently selected from H, OH, C₁-C₆ alkyl, C₂-C₆ alkenyl, and C₁-C₆ alkoxy;
   any two of R¹, R², R³, R⁴, R⁵, R⁶, R⁷, R⁸, R⁹, R^{10A}, R^{10B}, R^{11A}, and R^{11B} on adjacent carbon atoms can be taken together with the carbon atoms to which they are attached to form a double bond, a 3- to 6-membered ring heterocycloalkyl, or a C₃-C₆ cycloalkyl;
   o is an integer from 0 to 15;
   p is an integer from 0 to 15; and
   the sum of o and p is from 3 to 15.

Embodiment 26 is the composition of embodiment 25, wherein R^{B} is C₁-C₅ alkyl.

Embodiment 27 is the composition of embodiment 25, wherein R^{B} is C₂ alkyl or C₃ alkyl.

Embodiment 28 is the composition of any of embodiments 1-27, wherein each of the one or more monoglycerides independently comprises a compound of Formula I-i or Formula I-ii:

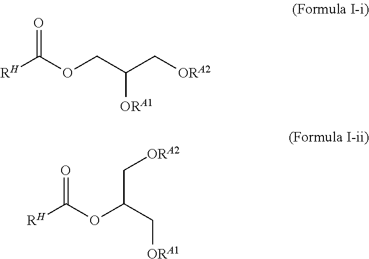

wherein:
   R^{A1} and R^{A2} are each independently selected from H and C₁-C₆ alkyl; and
   R^{H} is a C₃-C₂₇ side chain.

Embodiment 29 is the composition of embodiment 28, wherein R^{A1} and R^{A2} are each H.

Embodiment 30 is the composition of embodiment 28 or embodiment 29, wherein R H is a saturated, unsubstituted side chain.

Embodiment 31 is the composition of any of embodiments 28-30, wherein R^{H} is a C₁₁-C₂₁ side chain.

Embodiment 32 is the composition of any of embodiments 28-31, wherein the one or more monoglycerides comprises
a first compound of Formula I-i or Formula I-ii, wherein R^{H} is a C₁₅-C₂₇ side chain; and
a second compound of Formula I-i or Formula I-ii, wherein R^{H} is a C₃-C₁₃ side chain.

Embodiment 33 is the composition of any of embodiments 1-27, wherein each of the one or more monoglycerides independently comprises a compound of Formula IA-i or Formula

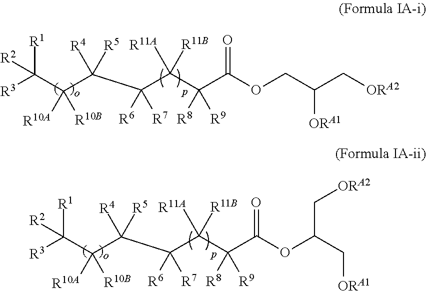

wherein:
   R^{A1} and R^{A2} are each independently selected from H and C₁-C₆ alkyl;
   R¹, R², R³, R⁴, R⁵, R⁶, R⁷, R⁸, and R⁹ are each independently selected from H, OH, C₁-C₆ alkyl, C₂-C₆ alkenyl, and C₁-C₆ alkoxy;
   each occurrence of R^{10A}, R^{10B}, R^{11A}, and R^{11B} is independently selected from H, OH, C₁-C₆ alkyl, C₂-C₆ alkenyl, and C₁-C₆ alkoxy;
   any two of R¹, R², R³, R⁴, R⁵, R⁶, R⁷, R⁸, R⁹, R^{10A}, R^{10B}, R^{11A}, and R^{11B} on adjacent carbon atoms can be taken together with the carbon atoms to which they are attached to form a double bond, a 3- to 6-membered ring heterocycloalkyl, or a C₃-C₆ cycloalkyl;
   o is an integer from 0 to 17;
   p is an integer from 0 to 17; and
   the sum of o and p is from 0 to 17.

Embodiment 34 is the composition of embodiment 33, wherein R^{A1} and R^{A2} are each H.

Embodiment 35 is the composition of any of embodiments 1-34, wherein each of the one or more salts present in the composition independently comprises a compound of Formula II:

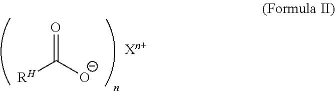

wherein:
   R^{H} is a C₃-C₂₇ side chain; and
   Xⁿ⁺ is a cationic moiety having formal charge n.

Embodiment 36 is the composition of embodiment 35, wherein
Xⁿ⁺ is is selected from Li⁺, Na⁺, K⁺, Ca⁺, Ca²⁺, Mg²⁺, Zn²⁺, Cu²⁺, and (R^{D})₄N⁺; and
each occurrence of R^{D} is selected from H, C₁-C₆ alkyl, C₃-C₆ cycloalkyl, C₃-C₆ heterocycloalkyl, aryl, and heteroaryl, wherein
   each C₁-C₆ alkyl is optionally substituted with 1-3 R^{E} independently selected from C₃-C₆ cycloalkyl, C₃-C₆ heterocycloalkyl, aryl, and heteroaryl; and
   optionally, one or more instances of R^{D} are taken together with the nitrogen atom to which they are attached to form a C₃-C₆ heterocycloalkyl.

Embodiment 37 is the composition of embodiment 35 or embodiment 36, wherein R^{H} is a saturated, unsubstituted side chain.

Embodiment 38 is the composition of any of embodiments 1-37, wherein each of the one or more salts present in the composition independently comprises a compound of Formula IIA:

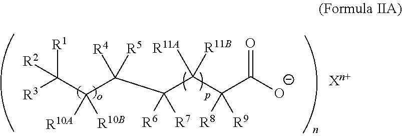

wherein:
   R¹, R², R³, R⁴, R⁵, R⁶, R⁷, R⁸, and R⁹ are each independently selected from H, OH, C₁-C₆ alkyl, C₂-C₆ alkenyl, and C₁-C₆ alkoxy;
   each occurrence of R^{10A}, R^{10B}, R^{11A}, and R′ is independently selected from H, OH, C₁-C₆ alkyl, C₂-C₆ alkenyl, and C₁-C₆ alkoxy;
   any two of R¹, R₂, R³, R⁴, R⁵, R⁶, R⁷, R⁸, R⁹, R^{10A}, R^{10B}, R^{11A}, and R^{11B} on adjacent carbon atoms can be taken together with the carbon atoms to which they are attached to form a double bond, a 3- to 6-membered ring heterocycloalkyl, or a C₃-C₆ cycloalkyl;
   o is an integer from 0 to 17;
   p is an integer from 0 to 17;
   the sum of o and p is from 0 to 17; and
   Xⁿ⁺ is a cationic moiety having formal charge n.

Embodiment 39 is the composition of embodiment 38, wherein
Xⁿ⁺ is is selected from Li⁺, Na⁺, K⁺, Ca⁺, Ca²⁺, Mg²⁺, Zn²⁺, Cu²⁺, and (R^{D})₄N⁺; and
each occurrence of R^{D} is selected from H, C₁-C₆ alkyl, C₃-C₆ cycloalkyl, C₃-C₆ heterocycloalkyl, aryl, and heteroaryl, wherein
   each C₁-C₆ alkyl is optionally substituted with 1-3 R^{E} independently selected from C₃-C₆ cycloalkyl, C₃-C₆ heterocycloalkyl, aryl, and heteroaryl; and
   optionally, one or more instances of R^{D} are taken together with the nitrogen atom to which they are attached to form a C₃-C₆ heterocycloalkyl.

Embodiment 40 is a mixture comprising
the composition of any of embodiments 1-39; and
a solvent.

Embodiment 41 is the mixture of embodiment 40, wherein the mixture comprises about 30 wt % to about 99.9 wt % of the solvent.

Embodiment 42 is the mixture of embodiment 40, wherein the mixture comprises about 90 wt % to about 99.5 wt % of the solvent.

Embodiment 43 is the mixture of any of embodiments 40-42, wherein the solvent comprises one or more of water, methanol, ethanol, isopropanol, butanol, acetone, ethyl acetate, chloroform, acetonitrile, tetrahydrofuran, diethyl ether, methyl tert-butyl ether.

Embodiment 44 is a coated agricultural product comprising an agricultural product and a layer disposed on a surface of the agricultural product, wherein the layer comprises the composition of any of embodiments 1-39.

Embodiment 45 is the coated agricultural product of embodiment 44, wherein the layer is disposed on a cuticular surface of the agricultural product.

Embodiment 46 is the coated agricultural product of embodiment 44 or embodiment 45, wherein a thickness of the layer is about 0.1 μm to about 20 μm.

Embodiment 47 is the coated agricultural product of any of embodiments 44-46, wherein a thickness of the layer is about 0.1 μm to about 10 μm.

Embodiment 48 is a method of coating an agricultural product, the method comprising
contacting a surface of the agricultural product with a mixture comprising a coating agent and a solvent, wherein the coating agent comprises
   one or more monoglycerides of a C₄-C₂₈ fatty acid; and
   one or more alkyl esters of a C₈-C₂₀ fatty acid;
wherein a ratio of a total number of moles of the one or more monoglycerides to a total number of moles of the one or more alkyl esters is about 100:1 to about 1:5; and
removing at least a portion of the solvent to form a coating on the surface of the agricultural product.

Embodiment 49 is the method of embodiment 48, wherein the surface is a cuticular surface of the agricultural product.

Embodiment 50 is the method of embodiment 48 or embodiment wherein contacting the surface comprises:
spraying the mixture onto the surface; or
immersing the agricultural product in the mixture.

Embodiment 51 is the method of any of embodiments 48-50, wherein removing at least a portion of the solvent comprises evaporating at least a portion of the solvent.

Embodiment 52 is the method of any of embodiments 48-51, wherein the solvent comprises one or more of water, methanol, ethanol, isopropanol, butanol, acetone, ethyl acetate, chloroform, acetonitrile, tetrahydrofuran, diethyl ether, methyl tert-butyl ether.

Embodiment 53 is the method of any of embodiments 48-52, further comprising adding the coating agent to the solvent to form the mixture.

Embodiment 54 is the method of any of embodiments 48-53, further comprising adding the one or more alkyl esters of a C₈-C₂₀ fatty acid to a pre-mixture comprising the solvent and the one or more monoglycerides of a C₄-C₂₈ fatty acid to form the mixture.

Embodiment 55 is the method of any of embodiments 48-54, wherein a concentration of the coating agent in the mixture is about 1 mg/mL to about 200 mg/mL.

Embodiment 56 is the method of any of embodiments 48-54, wherein a concentration of the coating agent in the mixture is about 25 mg/mL to about 150 mg/mL.

Embodiment 57 is the method of any of embodiments 48-56, wherein:
the one or more monoglycerides are present in a total amount of about 70 wt % to about 99 wt % of the coating agent; and
the one or more alkyl esters are present in a total amount of about 1 wt % to about 15 wt % of the coating agent.

Embodiment 58 is the method of any of embodiments 48-56, wherein:
the one or more monoglycerides are present in a total amount of about 15 wt % to about 85 wt % of the coating agent; and
the one or more alkyl esters are present in a total amount of about 15 wt % to about 75 wt % of the coating agent.

Embodiment 59 is the method of any of embodiments 48-59, wherein the ratio of the total number of moles of the one or more monoglycerides to the total number of moles of the one or more alkyl esters is about 50:1 to about 6:1.

Embodiment 60 is the method of any of embodiments 48-59, wherein the ratio of the total number of moles of the one or more monoglycerides to the total number of moles of the one or more alkyl esters is about 3:1 to about 1:3.

Embodiment 61 is the method of any of embodiments 48-60, wherein the one or more alkyl esters each independently comprise a C₁-C₅ alkyl ester.

Embodiment 62 is the method of any of embodiments 48-60, wherein each of the one or more alkyl esters independently comprise a methyl ester, an ethyl ester, a propyl ester, an isopropyl ester, a tert-butyl ester, or an iso-amyl ester.

Embodiment 63 is the method of any of embodiments 48-60, wherein at least one of the alkyl esters comprises an ethyl ester or a propyl ester.

Embodiment 64 is the method of any of embodiments 48-63, wherein the coating agent further comprises one or more salts of a C₄-C₂₈ fatty acid, wherein a ratio of a total number of moles of the one or more monoglycerides and the one or more alkyl esters to a total number of moles of the one or more salts is about 100:1 to about 4:1.

Embodiment 65 is the method of embodiment 64, wherein the one or more monoglycerides, the one or more alkyl esters, and the one or more salts make up at least 80 wt % of the coating agent.

Embodiment 66 is the method of any of embodiments 48-65, wherein the one or more monoglycerides and the one or more alkyl esters make up about 70 wt % to about 98 wt % of the coating agent.

Embodiment 67 is the method of any of embodiments 48-66, wherein the coating agent and the solvent make up at least 95 wt % of the mixture.

Embodiment 68 is a method of coating an agricultural product, the method comprising:
contacting a surface of the agricultural product with the mixture of any of embodiments 40-43; and
removing at least a portion of the solvent to form a coating on the surface of the agricultural product.

The details of one or more embodiments of the subject matter of this disclosure are set forth in the accompanying drawings and the description. Other features, aspects, and advantages of the subject matter will become apparent from the description, the drawings, and the claims.

### BRIEF DESCRIPTION OF DRAWINGS

FIG. 1 is a graph showing small-angle X-ray scattering (SAXS)/wide-angle X-ray scattering (WAXS) data collected from a monoglyceride film.

FIG. 2 is a graph showing SAXS/WAXS data collected from a film of a composition described herein.

FIG. 3 is a graph showing SAXS/WAXS data collected from an alkyl ester film.

FIG. 4 is a plot showing viscosity data collected from certain compositions described herein.

### DETAILED DESCRIPTION

The present disclosure relates to compositions including monoglycerides and alkyl esters of fatty acids. In particular, the compositions described herein can be coated onto an agricultural product to provide an improved barrier, e.g., to gas or water. Such coatings can better limit mass loss and/or CO₂ production from an agricultural product as compared to those lacking an alkyl ester of a fatty acid.

Reference will now be made in detail to certain embodiments of the disclosed subject matter. While the disclosed subject matter will be described in conjunction with the enumerated claims, it will be understood that the exemplified subject matter is not intended to limit the claims to the disclosed subject matter.

### Definitions

The terms “a,” “an,” and “the” are used herein to include one or more than one unless the context clearly dictates otherwise. The term “or” is used to refer to a nonexclusive “or” unless otherwise indicated. The statement “at least one of A and B” has the same meaning as “A, B, or A and B.” In addition, it is to be understood that the phraseology or terminology employed in this disclosure, and not otherwise defined, is for the purpose of description only and not of limitation. Any use of section headings is intended to aid reading of the document and is not to be interpreted as limiting; information that is relevant to a section heading may occur within or outside of that particular section.

Values expressed in a range format should be interpreted in a flexible manner to include not only the numerical values explicitly recited as the limits of the range, but also to include all the individual numerical values or sub-ranges encompassed within that range as if each numerical value and sub-range is explicitly recited. For example, a range of “about 0.1% to about 5%” or “about 0.1% to 5%” should be interpreted to include not just about 0.1% to about 5%, but also the individual values (for example, 1%, 2%, 3%, and 4%) and the sub-ranges (for example, 0.1% to 0.5%, 1.1% to 2.2%, 3.3% to 4.4%) within the indicated range. The statement “about X to Y” has the same meaning as “about X to about Y,” unless indicated otherwise. Likewise, the statement “about X, Y, or about Z” has the same meaning as “about X, about Y, or about Z,” unless indicated otherwise.

As used herein, the term “about” allows for a degree of variability in a value or range within 10% of a stated value or of a stated limit of a range.

In the methods described herein, the acts can be carried out in any order, except when a temporal or operational sequence is explicitly recited. Furthermore, specified acts can be carried out concurrently unless explicit claim language recites that they be carried out separately. For example, a claimed act of doing X and a claimed act of doing Y can be conducted simultaneously within a single operation, and the resulting process will fall within the literal scope of the claimed process.

As used herein, the term “monoglyceride” refers to the condensation product of one glycerol molecule and one fatty acid—that is, a glycerol group attached through an ester linkage to one fatty acid. Monoglycerides can, but need not necessarily be derived from a condensation reaction. For example, monoglycerides can be obtained by an esterification reaction between glycerol and a fatty acid, by transesterification of a triglyceride with glycerol (glycerolysis), etc. Monoglycerides can also be referred to as glyceryl monoalkanoates. Where the glycerol group is attached to the ester linkage at the 1-position (e.g., as in 2,3-dihydroxypropan-1-yl octadecanoate), the monoglyceride can be referred to as a 1-monoglyceride or a 1-glyceryl alkanoate (e.g., as in 1-glyceryl octadecanoate). Where the glycerol group is attached to the ester linkage at the 2-position (e.g., as in 1,3-dihydroxypropan-2-yl hexadecanoate), the monoglyceride can be referred to as a 2-monoglyceride or a 2-glyceryl alkanoate (e.g., as in 2-glyceryl hexadecanoate). The glycerol group of a monoglyceride can be unsubstituted (e.g., as in a 2,3-dihyrdroxpropan-1-yl alkanoate), or can be further substituted with one or more groups other than a fatty acid (e.g., as in a 1,3-dialkoxypropan-2-yl alkanoate).

The term “alkyl ester,” used in reference to a fatty acid, refers to the condensation product of an alkanol and a fatty acid—that is, an alkyl group attached through an ester linkage to one fatty acid. Alkyl esters can, but need not necessarily be derived from a condensation reaction. For example, alkyl esters can be obtained by an esterification reaction between an alkanol and a fatty acid, by transesterification of a monoglyceride, triglyceride, etc. Alkyl esters can also be referred to as alkyl alkanoates. For example, an ethyl ester of hexadecanoic acid can also be referred to as ethyl hexadecanoate.

As used herein, the term “fatty acid” refers to carboxylic acids having an aliphatic side chain. Fatty acids can be naturally or non-naturally occurring, and can include a side chain that is branched or unbranched (e.g., linear), substituted or unsubstituted, and saturated or unsaturated.

As used herein, the term “side chain” refers to the aliphatic portion of a fatty acid, or a portion thereof. Unless otherwise indicated, the side chain of a given fatty acid includes the carbon of the carboxylic acid group. For example, dodecanoic acid can be described as including a linear, saturated C₁₂ side chain, and can also be represented as R^{H}—C(O)OH, where R^{H} is a linear, saturated C₁₁ side chain. Side chains can be present in compounds other than fatty acids, such as, for example, esters or amides, and can, but need not necessarily be derived from a fatty acid. For example, dodecanamide can be described as an amide of a fatty acid, whether or not the compound was in fact derived from dodecanoic acid.

The term “salt,” used in reference to a disclosed compound (e.g., a fatty acid) refers to derivatives of the compound where the parent compound is modified by converting acid or base moieties to their salt form. Examples of such salts include, but are not limited to, mineral or organic acid salts of basic residues such as amine, inorganic (e.g., alkali) or organic salts of acidic residues such as carboxylic acids, and the like.

Where certain features of the compounds described herein are disclosed in groups or in ranges, such disclosure includes each and every individual sub-combination of the members of such groups and ranges. For example, the term “C₁-C₆ alkyl” includes (without limitation) methyl, ethyl, C₃ alkyl, C₄ alkyl, C₅ alkyl, and C₆ alkyl.

As used herein, the term “n-membered,” where n is an integer, typically describes the number of ring-forming atoms in a moiety where the number of ring-forming atoms is n. For example, piperidinyl is an example of a 6-membered heterocycloalkyl ring, and 1,2,3,4-tetrahydro-naphthalene is an example of a 10-membered cycloalkyl group.

As used herein, the term “substituted” means that an atom or group of atoms formally replaces hydrogen as a “substituent” attached to another group. “Substituted,” unless otherwise indicated, refers to any level of substitution, e.g., mono-, di-, tri-, tetra- or penta-substitution, where such substitution is permitted. The substituents are independently selected, and substitution may be at any chemically accessible position. Substitution at a given atom is limited by valency. Substitution at a given atom results in a chemically stable molecule. The phrase “optionally substituted” means unsubstituted or substituted. A single divalent substituent, e.g., oxo, can replace two hydrogen atoms.

As used herein, the term “Cₙ-Cₘ” indicates a range which includes the endpoints, wherein n and m are integers and indicate the number of carbons. Examples include C₁-C₄, C₁-C₆ and the like.

As used herein, the term “alkyl” refers to a saturated hydrocarbon group that may be straight-chained or branched. The term “Cₙ-Cₘ alkyl” refers to an alkyl group having n to m carbon atoms. An alkyl group formally corresponds to an alkane with one C—H bond replaced by the point of attachment of the alkyl group to the remainder of the compound. Examples of alkyl moieties include, but are not limited to, chemical groups such as methyl, ethyl, n-propyl, isopropyl, n-butyl, tert-butyl, isobutyl, sec-butyl; higher homologs such as 2-methyl-1-butyl, n-pentyl, 3-pentyl, n-hexyl, 1,2,2-trimethylpropyl, and the like.

As used herein, the term “alkenyl” refers to a straight-chain or branched hydrocarbon group corresponding to an alkyl group having one or more double carbon-carbon bonds. An alkenyl group formally corresponds to an alkene with one C—H bond replaced by the point of attachment of the alkenyl group to the remainder of the compound. The term “Cₙ-Cₘ alkenyl” refers to an alkenyl group having n to m carbons. Example alkenyl groups include, but are not limited to, ethenyl, n-propenyl, isopropenyl, n-butenyl, sec-butenyl and the like.

As used herein, the term “alkoxy” refers to a group of formula —O-alkyl, wherein the alkyl group is as defined above. The term “Cₙ-Cₘ alkoxy” refers to an alkoxy group, the alkyl group of which has n to m carbons. Example alkoxy groups include methoxy, ethoxy, propoxy (e.g., n-propoxy and isopropoxy), t-butoxy and the like.

As used herein, the term “cycloalkyl” refers to a non-aromatic hydrocarbon ring system (monocyclic, bicyclic, or polycyclic), including cyclized alkyl and alkenyl groups. The term “Cₙ-Cₘ cycloalkyl” refers to a cycloalkyl that has n to m ring member carbon atoms. Cycloalkyl groups can include fused, bridged, and/or spiro bicyclic or polycyclic ring systems. Examples of cycloalkyl groups include, but are not limited to, cyclopropyl, cyclobutyl, cyclopentyl, cyclohexyl, cycloheptyl, cyclopentenyl, cyclohexenyl, cyclohexadienyl, cycloheptatrienyl, norbornyl, norpinyl, norcarnyl, bicyclo[1.1.0]butanyl, bicyclo[1.1.1]pentanyl, bicyclo[2.1.0]pentanyl, bicyclo[2.2.0]hexanyl, bicyclo[3.1.0]hexanyl, bicyclo[3.2.0]heptanyl, and bicyclo[3.3.0]-octanyl, bicyclo[2.1.1]hexanyl, bicyclo[2.2.1]heptanyl and bicyclo[1.1.1]pentanyl, and the like.

As used herein, the term “heterocycloalkyl” refers to a non-aromatic ring system (monocyclic, bicyclic, or polycyclic), which may optionally contain one or more alkenylene groups as part of the ring structure, which has at least one heteroatom ring member independently selected from nitrogen, sulfur, oxygen, and phosphorus. The term “n- to m-membered ring heterocycloalkyl” refers to a heterocycloalkyl that has n to m ring-forming atoms. Ring-forming carbon atoms and heteroatoms of a heterocycloalkyl group can be optionally oxidized to form an oxo or sulfido group or other oxidized linkage (e.g., C(O), S(O), C(S), S(O)₂, N-oxide, etc.) or a nitrogen atom can be quaternized. The heterocycloalkyl group can be attached through a ring-forming carbon atom or a ring-forming heteroatom. Heterocycloalkyl groups can include double bonds, for example, up to 3 double bonds. Examples of heterocycloalkyl groups include, but are not limited to, azetidinyl, dihydrofuranyl, dihydrothiophenyl, tetrahydrothiophenyl, tetrahydrofuranyl, tetrahydrotriazinyl, tetrahydropyrazolyl, tetrahydrooxazinyl, tetrahydropyrimidinyl, octahydrobenzofuranyl, octahydrobenzimidazolyl, octahydrobenzothiazolyl, imidazolidinyl, pyrrolidinyl, piperidinyl, piperazinyl, oxazolidinyl, thiazolidinyl, pyrazolidinyl, thiomorpholinyl, tetrahydropyranyl, tetrahydrothiazinyl, tetrahydrothiadiazinyl, tetrahydro-oxazolyl, morpholinyl, oxetanyl, dioxetanyl, dioxolanyl, dioxanyl, oxapanyl, dioxapanyl, oxacanyl, dioxacanyl, tetrahydrodiazinyl, oxazinyl, oxathiazinyl, quinuclidinyl, chromanyl, isochromanyl, dihydrobenzodioxinyl, benzodioxolyl, benzoxazinyl, indolinyl, dihydrobenzofuranyl, tetrahydroquinolyl, isochromyl, dihydro-1H-isoindolyl, 2-azabicyclo[2.2.1]heptanonyl, 3-azabicyclo[3.1.0]hexanyl, 3-azabicyclo[4.1.0]heptanyl, and the like. Further examples of heterocycloalkyl groups include tetrahydrofuran-2-yl, tetrahydrofuran-3-yl, imidazolidin-1-yl, imidazolidin-2-yl, imidazolidin-4-yl, pyrrolidin-1-yl, pyrrolidin-2-yl, pyrrolidin-3-yl, piperidin-1-yl, piperidin-2-yl, piperidin-3-yl, piperidin-4-yl, piperazin-1-yl, piperazin-2-yl, 1,3-oxazolidin-3-yl, 1,4-oxazepan-1-yl, isothiazolidinyl, 1,3-thiazolidin-3-yl, 1,2-pyrazolidin-2-yl, 1,2-tetrahydrothiazin-2-yl, 1,3-thiazinan-3-yl, 1,2-tetrahydrodiazin-2-yl, 1,3-tetrahydrodiazin-1-yl, 1,4-oxazin-4-yl, oxazolidinonyl, 2-oxo-piperidinyl (e.g., 2-oxo-piperidin-1-yl), and the like.

Compositions

Provided herein are compositions including one or more monoglycerides of a C₄-C₂₈ fatty acid and one or more alkyl esters of a C₈—Cao fatty acid.

In some embodiments, the one or more monoglycerides are present in a total amount of about 15 wt % to about 99 wt % of the composition, for example, about 15 wt % to about 85 wt %, about 15 wt % to about 65 wt %, about 25 wt % to about 85 wt %, about 25 wt % to about 65 wt %, about 35 wt % to about 85 wt %, about 35 wt % to about 65 wt %, about 70 wt % to about 99 wt %, about 70 wt % to about 96 wt %, about 80 wt % to about 99 wt %, or about 80 wt % to about 96 wt % of the composition.

In some embodiments, the one or more alkyl esters are present in a total amount of about 1 wt % to about 75 wt % of the composition, for example, about 1 wt % to about 15 wt %, about 1 wt % to about 10 wt %, about 2.5 wt % to about 15 wt %, about 2.5 wt % to about 10 wt %, about 5 wt % to about 15 wt %, about 5 wt % to about 10 wt %, about 15 wt % to about 75 wt %, about 15 wt % to about 55 wt %, about 25 wt % to about 75 wt %, about 25 wt % to about 55 wt %, about 35 wt % to about 75 wt %, or about 35 wt % to about 55 wt %.

In some embodiments, a ratio of a total number of moles of the one or more monoglycerides to a total number of moles of the one or more alkyl esters is about 100:1 to about 1:5, for example, about 100:1 to about 5:1, about 100:1 to about 7:1, about 50:1 to about 5:1, about 50:1 to about 7:1, about 25:1 to about 5:1, about 25:1 to about 7:1, about 5:1 to about 1:5, about 5:1 to about 1:2, about 3:1 to about 1:5, about 3:1 to about 1:2, about 2:1 to about 1:5, or about 2:1 to about 1:2.

In some embodiments, the one or more monoglycerides and the one or more alkyl esters make up about 70 wt % to about 99 wt % of the composition, for example, about 70 wt % to about 96 wt %, about 80 wt % to about 99 wt %, about 80 wt % to about 96 wt %, about 85 wt % to about 99 wt %, or about 85 wt % to about 96 wt % of the composition.

In some embodiments, the composition further includes one or more salts of a C₄-C₂₈ fatty acid. In some embodiments, the one or more salts are present in a total amount of about 0.1 wt % to about 30 wt % of the composition, about 0.1 wt % to about 15 wt %, about 0.1 wt % to about 10 wt %, about 1 wt % to about 30 wt %, about 1 wt % to about 15 wt %, about 1 wt % to about 10 wt %, about 2 wt % to about 30 wt %, about 2 wt % to about 15 wt %, or about 2 wt % to about 10 wt % of the composition. In some embodiments, a ratio of a total number of moles of the one or more monoglycerides and the one or more alkyl esters to a total number of moles of the one or more salts is about 100:1 to about 4:1, for example, about 100:1 to about 8:1, about 75:1 to about 4:1, about 75:1 to about 4:1, about 50:1 to about 4:1, or about 50:1 to about 8:1. In some embodiments, the one or more monoglycerides, the one or more alkyl esters, and the one or more salts make up at least about 80 wt % of the composition, for example, at least about 85 wt %, at least about 90 wt %, at least about 95 wt %, or at least about 99 wt % of the composition.

Monoglycerides of a C₄-C₂₈ Fatty Acid

The compositions described herein include one or more monoglycerides of a C₄-C₂₈ fatty acid. In some embodiments, the composition includes one monoglyceride of a C₄-C₂₈ fatty acid. In some embodiments, the composition includes two, three, or more monoglycerides of a C₄-C₂₈ fatty acid, for example, two monoglycerides of a C₄-C₂₈ fatty acid. In some embodiments, the monoglycerides include one or more monoglycerides of a naturally occurring fatty acid.

The monoglycerides can include one or more 1-monoglycerides, one or more 2-monoglycerides, or a mixture thereof. In some embodiments, the monoglycerides include one or more 2,3-dihydroxypropan-1-yl esters of a fatty acid, one or more 1,3-dihydroxypropan-2-yl esters of a fatty acid, or a mixture thereof. In some embodiments, 1-monoglycerides make up at least about 50 wt %, at least about 70 wt %, at least about 80 wt %, at least about 90 wt %, or about 100 wt % of the monoglycerides present in the composition. In some embodiments, 1-monoglycerides make up about 70 wt % to about 100 wt %, about 70 wt % to about 90 wt %, about 75 wt % to about 100 wt %, about 75 wt % to about 90 wt %, about 80 wt % to about 100 wt %, or about 80 wt % to about 90 wt % of the monoglycerides present in the composition.

In some embodiments, the monoglycerides include one or more monoglycerides of a C₆-C₂₈ fatty acid, a C₈-C₂₈ fatty acid, a C₄-C₂₄ fatty acid, a C₆-C₂₄ fatty acid, a C₁₂-C₂₄ fatty acid, a C₄-C₂₂ fatty acid, a C₆-C₂₂ fatty acid, or a C₁₂-C₂₂ fatty acid. In some embodiments, one or more of the monoglycerides include an unsubstituted side chain, for example, an unsubstituted C₁₂-C₂₂ side chain. In some embodiments, one or more of the monoglycerides include a linear side chain, for example, a linear C₁₂-C₂₂ side chain. In some embodiments, one or more of the monoglycerides include a saturated side chain, for example, a saturated C₁₂-C₂₂ side chain.

In some embodiments, the monoglycerides include one or more compounds of Formula I-i:

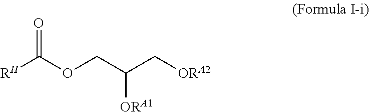

wherein:
   R^{A1} and R^{A2} are each independently selected from H and C₁-C₆ alkyl; and
   R^{H} is a C₃-C₂₇ side chain.

In some embodiments, the monoglycerides include one or more compounds of Formula I-ii:

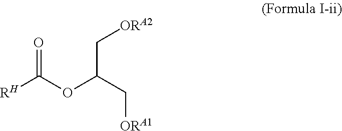

wherein:
   R^{A1} and R^{A2} are each independently selected from H and C₁-C₆ alkyl; and
   R^{H} is a C₃-C₂₇ side chain.

In some embodiments, each of the one or more monoglycerides independently includes a compound of Formula I-i or Formula I-ii. In some embodiments of Formula I-i or Formula I-ii, R^{A1} and R^{A2} are each H. In some embodiments of Formula I-i or Formula I-ii, R^{H} is a saturated side chain. In some embodiments of Formula I-i or Formula I-ii, R^{H} is an unsubstituted side chain. In some embodiments of Formula I-i or Formula I-ii, R^{H} is a linear side chain. In some embodiments of Formula I-i or Formula I-ii, R^{H} is a C₅-C₁₇ side chain. In some embodiments of Formula I-i or Formula I-ii, R^{H} is a C₁₁-C₂₁ side chain.

In some embodiments, the monoglycerides include a first compound of Formula I-i or Formula I-ii, where R^{H} is a C₁₅-C₂₇ side chain; and a second compound of Formula I-i or Formula I-ii, where R^{H} is a C₃-C₁₃ side chain. In some embodiments, R^{H} of the first compound is a C₁₅-C₂₁ side chain, and R H of the second compound is a C₁₁-C₁₃ side chain.

In some embodiments, the monoglycerides include one or more compounds of Formula IA-i:

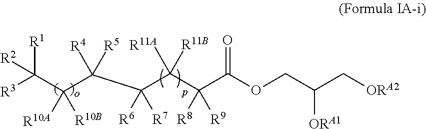

wherein:
   R^{A1} and R^{A2} are each independently selected from H and C₁-C₆ alkyl;
   R¹, R², R³, R⁴, R⁵, R⁶, R⁷, R⁸, and R⁹ are each independently selected from H, OH, C₁-C₆ alkyl, C₂-C₆ alkenyl, and C₁-C₆ alkoxy;
   each occurrence of R^{10A}, R^{10B}, R^{11A}, and R^{11B} is independently selected from H, OH, C₁-C₆ alkyl, C₂-C₆ alkenyl, and C₁-C₆ alkoxy;
   any two of R¹, R², R³, R⁴, R⁵, R⁶, R⁷, R⁸, R⁹, R^{10A}, R^{10B}, R^{11A}, and R^{11B} on adjacent carbon atoms can be taken together with the carbon atoms to which they are attached to form a double bond, a 3- to 6-membered ring heterocycloalkyl, or a C₃-C₆ cycloalkyl;
   o is an integer from 0 to 17;
   p is an integer from 0 to 17; and
   the sum of o and p is from 0 to 17.

In some embodiments, the monoglycerides include one or more compounds of Formula IA-ii:

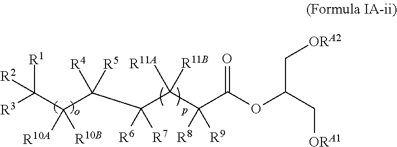

wherein:
   R^{A1} and R^{A2} are each independently selected from H and C₁-C₆ alkyl;
   R¹, R², R³, R⁴, R⁵, R⁶, R⁷, R⁸, and R⁹ are each independently selected from H, OH, C₁-C₆ alkyl, C₂-C₆ alkenyl, and C₁-C₆ alkoxy;
   each occurrence of R^{10A}, R^{10B}, R^{11A}, and R^{11B} is independently selected from H, OH, C₁-C₆ alkyl, C₂-C₆ alkenyl, and C₁-C₆ alkoxy;
   any two of R¹, R², R³, R⁴, R⁵, R⁶, R⁷, R⁸, R⁹, R^{10A}, R^{10B}, R^{11A}, and R^{11B} on adjacent carbon atoms can be taken together with the carbon atoms to which they are attached to form a double bond, a 3- to 6-membered ring heterocycloalkyl, or a C₃-C₆ cycloalkyl;
   o is an integer from 0 to 17;
   p is an integer from 0 to 17; and
   the sum of o and p is from 0 to 17.

In some embodiments, each of the one or more monoglycerides independently includes a compound of Formula IA-i or Formula IA-ii. In some embodiments of Formula IA-i or Formula IA-ii, R^{A1} and R^{A2} are each H. In some embodiments of Formula IA-i or Formula IA-ii, each of R¹, R², R³, R⁴, R⁵, R⁶, R⁷, R⁸, and R⁹, and each occurrence of R^{10A}, R^{10B}, R^{11A}, and R^{11B} are independently selected from H and OH. In some embodiments of Formula IA-i or Formula IA-ii, any two of R¹, R², R³, R⁴, R⁵, R⁶, R⁷, R⁸, R⁹, R^{10A}, R^{10B}, R^{11A}, and R^{11B} on adjacent carbon atoms are taken together with the carbon atoms to which they are attached to form an oxirane. In some embodiments of Formula IA-i or Formula IA-ii, two pairs, one pair, or none of R¹, R², R³, R⁴, R⁵, R⁶, R⁷, R⁸, and R⁹, and each occurrence of R^{10A}, R^{10B}, R^{11A}, and R^{11B} on adjacent carbon atoms are taken together with the carbon atoms to which they are attached to form a double bond. In some embodiments of Formula IA-i or Formula IA-ii, one pair, or none of R¹, R², R³, R⁴, R⁵, R⁶, R⁷, and R⁹, and each occurrence of R^{10A}, R^{10B}, R^{11A}, and R^{11B} on adjacent carbon atoms are taken together with the carbon atoms to which they are attached to form an oxirane. In some embodiments of Formula IA-i or Formula IA-ii, two, one, or none of R¹, R², R³, R⁴, R⁵, R⁶, R⁷, R⁸, and R⁹, and each occurrence of R^{10A}, R^{10B}, R^{11A}, and R^{11B} are OH.

In some embodiments of Formula IA-i or Formula IA-ii, the sum of o and p is from 0 to 13, from 0 to 11, from 0 to 9, from 0 to 7, from 5 to 17, from 5 to 13, from 5 to 11, from 5 to 9, from 5 to 7, from 7 to 17, from 7 to 13, from 7 to 11, from 7 to 9, from 9 to 17, from 9 to 13, from 9 to 11, from 11 to 17, or from 11 to 13.

In some embodiments, the monoglycerides include one or more 1-monoglycerides or 2-monoglycerides, for example, 2,3-dihydroxypropan-1-yl esters or 1,3-dihydroxypropan-2-yl esters, of heptanoic acid, octanoic acid, nonanoic acid, decanoic acid, undecanoic acid, dodecanoic acid, tridecanoic, tetradecanoic acid, pentadecanoic acid, hexadecanoic acid, heptadecanoic acid, octadecanoic acid, nonadecanoic acid, eicosanoic acid, heneicosanoic acid or docosanoic acid.

Salts of a C₄-C₂₈ Fatty Acid

The compositions described herein can include one or more salts of a C₄-C₂₈ fatty acid. In some embodiments, the composition includes one salt of a C₄-C₂₈ fatty acid. In some embodiments, the composition includes two, three, or more salts of a C₄-C₂₈ fatty acid, for example, two salts of a C₄-C₂₈ fatty acid. In some embodiments, the salts include one or more salts of a naturally occurring fatty acid.

In some embodiments, the salts include one or more salts of a C₆-C₂₈ fatty acid, a C₈-C₂₈ fatty acid, a C₄-C₂₄ fatty acid, a C₆-C₂₄ fatty acid, a C₁₂-C₂₄ fatty acid, a C₄-C₂₂ fatty acid, a C₆-C₂₂ fatty acid, or a C₁₂-C₂₂ fatty acid. In some embodiments, the salts include two salts of a C₁₂-C₂₂ fatty acid, for example, a salt of a C₁₆ fatty acid and a Cis fatty acid. In some embodiments, one or more of the salts include an unsubstituted side chain, for example, an unsubstituted C₁₂-C₂₂ side chain. In some embodiments, one or more of the salts include a linear side chain, for example, a linear C₁₂-C₂₂ side chain. In some embodiments, one or more of the salts include a saturated side chain, for example, a saturated C₁₂-C₂₂ side chain. In some embodiments, the salts include one or more compounds of Formula II:

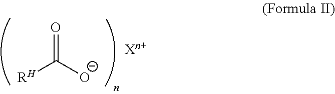

wherein:
   R^{H} is a C₃-C₂₇ side chain; and
   Xⁿ⁺ is a cationic moiety having formal charge n.

In some embodiments, each of the one or more salts independently includes a compound of Formula II. In some embodiments of Formula II, Xⁿ⁺ is selected from Li⁺, Na⁺, K⁺, Cs⁺ Ag⁺, Ca²⁺, Mg²⁺, Zn²⁺, Cu²⁺, and (R^{D})₄N⁺, where each occurrence of R^{D} is selected from H, C₁-C₆ alkyl, C₃-C₆ cycloalkyl, C₃-C₆ heterocycloalkyl, aryl, and heteroaryl, and where each C₁-C₆ alkyl is optionally substituted with 1-3 R^{E} independently selected from C₃-C₆ cycloalkyl, C₃-C₆ heterocycloalkyl, aryl, and heteroaryl. In some embodiments, Xⁿ⁺ is (R^{D})₄N⁺, and one or more instances of R^{D} are taken together with the nitrogen atom to which they are attached to form a C₃-C₆ heterocycloalkyl. In some embodiments of Formula II, Xⁿ⁺ is selected from Na⁺, K⁺, Ca⁺, Mg⁺, and Zn⁺. In some embodiments of Formula II, R^{H} is a saturated side chain. In some embodiments of Formula II, R^{H} is an unsubstituted side chain. In some embodiments of Formula II, R^{H} is a linear side chain. In some embodiments of Formula II, R^{H} is a C₅-C₁₇ side chain. In some embodiments of Formula II, R^{H} is a C₁₁-C₂₁ side chain.

In some embodiments, the salts include one or more compounds of Formula IIA:

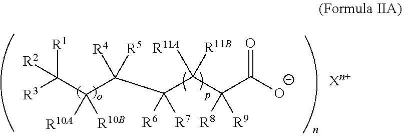

wherein:
   R¹, R², R³, R⁴, R⁵, R⁶, R⁷, R⁸, and R⁹ are each independently selected from H, OH, C₁-C₆ alkyl, C₂-C₆ alkenyl, and C₁-C₆ alkoxy;
   each occurrence of R^{10A}, R^{10B}, R^{11A}, and R′ is independently selected from H, OH, C₁-C₆ alkyl, C₂-C₆ alkenyl, and C₁-C₆ alkoxy;
   any two of R¹, R², R³, R⁴, R⁵, R⁶, R⁷, R⁸, R⁹, R^{10A}, R^{10B}, R^{11A}, and R^{11B} on adjacent carbon atoms can be taken together with the carbon atoms to which they are attached to form a double bond, a 3- to 6-membered ring heterocycloalkyl, or a C₃-C₆ cycloalkyl;
   o is an integer from 0 to 17;
   p is an integer from 0 to 17;
   the sum of o and p is from 0 to 17; and
   Xⁿ⁺ is a cationic moiety having formal charge n.

In some embodiments, each of the one or more salts independently includes a compound of Formula IIA. In some embodiments of Formula IIA, Xⁿ⁺ is selected from Li⁺, Na⁺, K⁺, Ca⁺, Ag⁺, Ca²⁺, Mg²⁺, Zn²⁺, Cu²⁺, and (R^{D})₄N⁺, where each occurrence of R^{D} is selected from H, C₁-C₆ alkyl, C₃-C₆ cycloalkyl, C₃-C₆ heterocycloalkyl, aryl, and heteroaryl, and where each C₁-C₆ alkyl is optionally substituted with 1-3 R^{E} independently selected from C₃-C₆ cycloalkyl, C₃-C₆ heterocycloalkyl, aryl, and heteroaryl. In some embodiments, Xⁿ⁺ is (R^{D})₄N⁺, and one or more instances of R^{D} are taken together with the nitrogen atom to which they are attached to form a C₃-C₆ heterocycloalkyl. In some embodiments of Formula II, Xⁿ⁺ is selected from Na⁺, K⁺, Ca²⁺, Mg²⁺, and Zn²⁺.

In some embodiments of Formula IIA, each of R¹, R², R³, R⁴, R⁵, R⁶, R⁷, R⁸, and R⁹, and each occurrence of R^{10A}, R^{10B}, R^{11A}, and R^{11B} are independently selected from H and OH. In some embodiments of Formula IIA, any two of R¹, R², R³, R⁴, R⁵, R⁶, R⁷, R⁸, R⁹, R^{10A}, R^{10B}, R^{11A}, and R^{11B} on adjacent carbon atoms are taken together with the carbon atoms to which they are attached to form an oxirane. In some embodiments of Formula IIA, two pairs, one pair, or none of R¹, R², R³, R⁴, R⁵, R⁶, R⁷, R⁸, and R⁹, and each occurrence of R^{10A}, R^{10B}, R^{11A}, and R^{11B} on adjacent carbon atoms are taken together with the carbon atoms to which they are attached to form a double bond. In some embodiments of Formula IIA, one pair, or none of R¹, R², R³, R⁴, R⁵, R⁶, R⁷, R⁸, and R⁹, and each occurrence of R^{10A}, R^{10B}, R^{11A}, and R^{11B} on adjacent carbon atoms are taken together with the carbon atoms to which they are attached to form an oxirane. In some embodiments of Formula IIA, two, one, or none of R¹, R², R³, R⁴, R⁵, R⁶, R⁷, R⁸, and R⁹, and each occurrence of R^{10A}, R^{10B}, R^{11A}, and R^{11B} are OH.

In some embodiments of Formula IIA, the sum of o and p is from 0 to 13, from 0 to 11, from 0 to 9, from 0 to 7, from 5 to 17, from 5 to 13, from 5 to 11, from 5 to 9, from 5 to 7, from 7 to 17, from 7 to 13, from 7 to 11, from 7 to 9, from 9 to 17, from 9 to 13, from 9 to 11, from 11 to 17, or from 11 to 13.

In some embodiments, the salts include one or more salts, for example, sodium, potassium, silver, calcium, magnesium or zinc salts, of a saturated, linear, unsubstituted fatty acid. In some embodiments, the salts include one or more salts, for example, sodium, potassium, silver, calcium, magnesium or zinc salts, of heptanoic acid, octanoic acid, nonanoic acid, decanoic acid, undecanoic acid, dodecanoic acid, tridecanoic, tetradecanoic acid, pentadecanoic acid, hexadecanoic acid, heptadecanoic acid, octadecanoic acid, nonadecanoic acid, eicosanoic acid, heneicosanoic acid or docosanoic acid.

Alkyl Esters

The compositions described herein include one or more alkyl esters of a C₄-C₂₈ fatty acid. In some embodiments, the alkyl esters include one or more C₁-C₅ alkyl esters. In some embodiments, each of the alkyl esters is independently a C₁-C₅ alkyl ester. In some embodiments, the alkyl esters include a methyl ester, an ethyl ester, a propyl ester, an isopropyl ester, a tert-butyl ester, an iso-amyl ester, or any combination thereof. In some embodiments, at least one of the alkyl esters includes an ethyl ester or propyl ester.

In some embodiments, the alkyl esters include one or more compounds of Formula III:

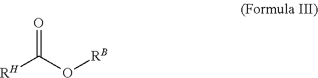

wherein:
   R^{B} is C₁-C₈ alkyl; and
   R^{H} is a C₇-C₁₉ side chain.

In some embodiments, each of the one or more alkyl esters independently includes a compound of Formula III. In some embodiments of Formula III, R^{B} is C₁-C₅ alkyl, C₁-C₃ alkyl, C₂ alkyl, or C₃ alkyl. In some embodiments, R^{H} is a saturated side chain. In some embodiments, R^{H} is an unsubstituted side chain. In some embodiments, R^{H} is a linear side chain. In some embodiments, R^{H} is a C₇-C₁₇ side chain, C₉-C₁₉ side chain, a C₉-C₁₇ side chain, a C₁₁-C₁₉ side chain, or a C₁₁-C₁₇ side chain.

In some embodiments, the alkyl esters include one or more compounds of Formula IIIA:

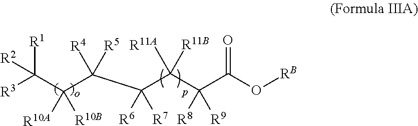

wherein:
   R^{B} is C₁-C₈ alkyl;
   R¹, R², R³, R⁴, R⁵, R⁶, R⁷, R⁸, and R⁹ are each independently selected from H, OH, C₁-C₆ alkyl, C₂-C₆ alkenyl, and C₁-C₆ alkoxy;
   each occurrence of R^{10A}, R^{10B}, R^{11A}, and R^{11B} is independently selected from H, OH, C₁-C₆ alkyl, C₂-C₆ alkenyl, and C₁-C₆ alkoxy;
   any two of R¹, R², R³, R⁴, R⁵, R⁶, R⁷, R⁸, R⁹, R^{10A}, R^{10B}, R^{11A}, and R^{11B} on adjacent carbon atoms can be taken together with the carbon atoms to which they are attached to form a double bond, a 3- to 6-membered ring heterocycloalkyl, or a C₃-C₆ cycloalkyl;
   o is an integer from 0 to 15;
   p is an integer from 0 to 15; and
   the sum of o and p is from 3 to 15.

In some embodiments, each of the one or more alkyl esters independently includes a compound of Formula IIIA. In some embodiments of Formula IIIA, R^{B} is C₁-C₅ alkyl, C₁-C₃ alkyl, C₂ alkyl, or C₃ alkyl. In some embodiments of Formula IIIA, each of R¹, R², R³, R⁴, R⁵, R⁶, R⁷, R⁸, and R⁹, and each occurrence of R^{10A}, R^{10B}, R^{11A}, and R^{11B} are independently selected from H and OH. In some embodiments of Formula any two of R¹, R², R³, R⁴, R⁵, R⁶, R⁷, R⁸, R⁹, R^{10A}, R^{10B}, R^{11A}, and R′ on adjacent carbon atoms are taken together with the carbon atoms to which they are attached to form an oxirane. In some embodiments of Formula IIIA, two pairs, one pair, or none of R¹, R², R³, R⁴, R⁵, R⁶, R⁷, R⁸, and R⁹, and each occurrence of R^{10A}, R^{10B}, R^{11A}, and R^{11B} on adjacent carbon atoms are taken together with the carbon atoms to which they are attached to form a double bond. In some embodiments of Formula IIIA, one pair, or none of R¹, R², R³, R⁴, R⁵, R⁶, R⁷, R⁸, and R⁹, and each occurrence of R^{10A}, R^{10B}, R^{11A}, and R^{11B}, on adjacent carbon atoms are taken together with the carbon atoms to which they are attached to form an oxirane. In some embodiments of Formula IIIA, two, one, or none of R¹, R², R³, R⁴, R⁵, R⁶, R⁷, R⁸, and R⁹, and each occurrence of R^{10A}, R^{10B}, R^{11A}, and R^{11B} are OH.

In some embodiments, the monoglycerides include one or more alkyl esters, for example, ethyl esters or propyl esters, of heptanoic acid, octanoic acid, nonanoic acid, decanoic acid, undecanoic acid, dodecanoic acid, tridecanoic, tetradecanoic acid, pentadecanoic acid, hexadecanoic acid, heptadecanoic acid, octadecanoic acid, nonadecanoic acid, eicosanoic acid, heneicosanoic acid or docosanoic acid, 9-hydroxyhexadecanoic acid, 10-hydroxyhexadecanoic acid, 9,10-dihydroxyhexadecanoic acid, 16-hydroxyhexadecanoic acid, 9,16-dihydroxyhexadecanoic acid, 10,16-dihydroxyhexadecanoic acid, 9,10,16-trihydroxyhexadecanoic acid, 9,10-epoxyhexadecanoic acid, (9Z)-hexadec-9-enoic acid, (9E)-hexadec-9-enoic acid, 9,10-epoxy-16-hydroxyhexadecanoic acid, 16-hydroxy-(9Z)-hexadec-9-enoic acid, 16-hydroxy-(9E)-hexadec-9-enoic acid, 9-hydroxyoctadecanoic acid, 10-hydroxyoctadecanoic acid, 9,10-dihydroxyoctadecanoic acid, 18-hydroxyoctadecanoic acid, 9,18-dihydroxyoctadecanoic acid, 10,18-dihydroxyoctadecanoic acid, 9,10,18-trihydroxyoctadecanoic acid, 9,10-epoxyoctadecanoic acid, (9Z)-octadec-9-enoic acid, (9E)-octadec-9-enoic acid, 18-hydroxy-9,10-dihydroxyoctadecanoic acid, 18-hydroxy-(9Z)-octadec-9-enoic acid, 18-hydroxy-(9E)-octadec-9-enoic acid, (13Z)-docos-13-enoic acid, or (13E)-docos-13-enoic acid.

Additional Components

The compositions described herein can include one or more additional components, for example, components that are non-toxic and safe for consumption by humans and/or animals. For example, the composition can include direct or indirect food additives or food-contact substances approved by the U.S. Food and Drug Administration (FDA), components satisfying FDA regulatory requirements to be used as a food additive or food contact substance, or components generally recognized as safe (GRAS) by the FDA.

In some embodiments, the compositions described herein further include one or more fatty acids, for example, C₄-C₂₂ fatty acids. In some embodiments, the composition includes less than about 10 wt %, for example, less than about 5 wt %, less than about 2 wt %, less than about 1 wt %, or is free from one or more of triglycerides, diglycerides, acetylated monoglycerides, lactlyated monoglycerides, succinylated monoglycerides, sterols, bile acids, proteins, polysaccharides, phenols, lignans, aromatic acids, terpenoids, flavonoids, carotenoids, alkaloids, alcohols, alkanes, aldehydes, and any salts thereof.

Mixtures

Also provided herein are mixtures including a composition described herein and a solvent. In some embodiments, the mixture includes a dispersion of a composition described herein in a solvent. In some embodiments, the solvent includes water, ammonia, methanol, ethanol, isopropanol, butanol, acetone, ethyl acetate, chloroform, acetonitrile, tetrahydrofuran, diethyl ether, methyl tert-butyl ether, or any combination thereof. In some embodiments, the solvent includes water, ethanol, or a combination thereof. In some embodiments, the solvent includes water and one or more of ammonia, methanol, ethanol, isopropanol, butanol, acetone, ethyl acetate, chloroform, acetonitrile, tetrahydrofuran, diethyl ether, and methyl tert-butyl ether. In some embodiments, the solvent includes water and ammonia.

In some embodiments, the mixture includes about 30 wt % to about 99.9 wt %, about 30 wt % to about 99.5 wt %, about 30 wt % to about 99 wt %, about 50 wt % to about 99.9 wt %, about 50 wt % to about 99.5 wt %, about 50 wt % to about 99 wt %, about 90 wt % to about 99.9 wt %, about 90 wt % to about 99.5 wt %, or about 90 wt % to about 99 wt % of solvent.

In some embodiments, the concentration of the composition in the mixture is about 1 mg/mL to about 200 mg/mL, about 1 mg/mL to about 150 mg/mL, about 1 mg/mL to about 125 mg/mL, about 1 mg/mL to about 100 mg/mL, about 25 mg/mL to about 200 mg/mL, about 25 mg/mL to about 150 mg/mL, about 25 mg/mL to about 125 mg/mL, about 25 mg/mL to about 100 mg/mL, about 50 mg/mL to about 200 mg/mL, about 50 mg/mL to about 150 mg/mL, about 50 mg/mL to about 125 mg/mL, or about 50 mg/mL to about 100 mg/mL.

Coatings

Also provided herein are coated agricultural products including a layer formed from a composition described herein, disposed on a surface of the agricultural product. In some embodiments, the agricultural product is an edible agricultural product including, for example, fruits, vegetables, edible seeds and nuts, herbs, spices, produce, meat, eggs, dairy products, seafood, grains, or any other consumable item. In other embodiments, the agricultural product is an inedible agricultural product including, for example, inedible flowers, seeds, shoots, stems, leaves, whole plants, and the like. In some embodiments, the layer is disposed on an exterior surface (e.g., a cuticular surface) of the agricultural product.

In some embodiments, the layer has a thickness of about 0.1 μm to about 20 μm, for example, about 0.1 μm to about 15 μm, about 0.1 μm to about 10 μm, about 0.5 μm to about 20 μm, about 0.5 μm to about 15 μm, about 0.5 μm to about 10 μm, about 1 μm to about 20 μm, about 1 μm to about 15 μm, or about 1 μm to about 10 μm.

Coating Methods

Also provided herein are methods for coating an agricultural product, the methods including contacting a surface of the agricultural product with a mixture including a coating agent and a solvent, and removing at least a portion of the solvent to form a coating on the surface of the agricultural product. The coating agent includes one or more monoglycerides of a C₄-C₂₈ fatty acid, and one or more alkyl esters of a C₈-C₂₀ fatty acid. In some embodiments, the coating agent is a composition described herein. For example, in some embodiments, a ratio of a total number of moles of the one or more monoglycerides to a total number of moles of the one or more alkyl esters is about 100:1 to about 1:5. In some embodiments, the coating agent includes one or more monoglycerides of a C₄-C₂₈ fatty acid, present in a total amount of about 15 wt % to about 99 wt % of the coating agent, and one or more alkyl esters of a C₈-C₂₀ fatty acid, present in a total amount of 1 wt % to about 75 wt % of the coating agent.

In some embodiments of the coating method, the agricultural product is an edible agricultural product including, for example, fruits, vegetables, edible seeds and nuts, herbs, spices, produce, meat, eggs, dairy products, seafood, grains, or any other consumable item. In other embodiments of the coating method, the agricultural product is an inedible agricultural product including, for example, inedible flowers, seeds, shoots, stems, leaves, whole plants, and the like. In some embodiments, the method includes contacting an exterior surface (e.g., a cuticular surface) of the agricultural product with the coating agent-containing mixture.

In some embodiments of the coating method, contacting the surface of the agricultural product includes spraying the mixture onto the surface of the agricultural product. The mixture can be sprayed, for example, from a commercially available sprayer. In some embodiments, the mixture is aerosol-sprayed onto the surface of the agricultural product. In some embodiments of the coating method, contacting the surface of the agricultural product includes immersing the agricultural product in the mixture. In other embodiments of the coating method, the mixture can be brushed, dripped, drop-cast, rolled, dabbed, or poured on the surface of the agricultural product.

In some embodiments of the coating method, removing at least a portion of the solvent includes evaporating at least a portion of solvent. In some embodiments, the evaporation can be passive. In other embodiments, the evaporation can be active, for example, as in convective drying. In some embodiments of the coating method, the solvent includes water, methanol, ethanol, isopropanol, butanol, acetone, ethyl acetate, chloroform, acetonitrile, tetrahydrofuran, diethyl ether, methyl tert-butyl ether, or any combination thereof. In some embodiments of the coating method, the solvent includes water, ethanol, or a combination thereof. In some embodiments, the solvent includes water and one or more of ammonia, methanol, ethanol, isopropanol, butanol, acetone, ethyl acetate, chloroform, acetonitrile, tetrahydrofuran, diethyl ether, and methyl tert-butyl ether. In some embodiments, the solvent includes water and ammonia.

In some embodiments of the coating method, the concentration of the coating agent in the mixture is about 1 mg/mL to about 200 mg/mL, about 1 mg/mL to about 150 mg/mL, about 1 mg/mL to about 125 mg/mL, about 1 mg/mL to about 100 mg/mL, about 25 mg/mL to about 200 mg/mL, about 25 mg/mL to about 150 mg/mL, about 25 mg/mL to about 125 mg/mL, about 25 mg/mL to about 100 mg/mL, about 50 mg/mL to about 200 mg/mL, about 50 mg/mL to about 150 mg/mL, about 50 mg/mL to about 125 mg/mL, or about 50 mg/mL to about 100 mg/mL.

In some embodiments of the coating method, the one or more monoglycerides are present in a total amount of about 70 wt % to about 99 wt %, or about 15 wt % to about 85 wt % of the coating agent, and the one or more alkyl esters are present in a total amount of about 1 wt % to about 15 wt %, or about 15 wt % to about 75 wt % of the coating agent. In some embodiments, the ratio of the total number of moles of the one or more monoglycerides to the total number of moles of the one or more alkyl esters present in the coating agent is about 50:1 to about 6:1, or about 3:1 to about 1:3.

In some embodiments, the monoglycerides include a compound of Formula I-i, Formula I-ii, Formula IA-i, or Formula IA-ii described herein. In some embodiments, the alkyl esters include a compound of Formula III or Formula IIIA described herein. In some embodiments, the coating agent further includes a compound of Formula II or Formula IIA described herein.

In some embodiments, the one or more monoglycerides and the one or more alkyl esters make up about 70 wt % to about 99 wt % of the coating agent, for example, about 70 wt % to about 98 wt %, about 70 wt % to about 96 wt %, about 80 wt % to about 99 wt %, about 80 wt % to about 98 wt %, about 80 wt % to about 96 wt %, about 85 wt % to about 99 wt %, about 85 wt % to about 98 wt %, or about 85 wt % to about 96 wt % of the coating agent. In some embodiments, the coating agent further includes one or more salts of a C₄-C₂₈ fatty acid, and the one or more monoglycerides, the one or more alkyl esters, and the one or more salts make up at least about 80 wt % of the composition, for example, at least about 85 wt %, at least about 90 wt %, at least about 95 wt %, at least about 97.5 wt %, at least about 98 wt %, or at least about 99 wt % of the coating agent.

### EXAMPLES

### Example 1. Preparation of Alkyl Esters and Mixtures

When available, ethyl esters of fatty acids were purchased commercially. Other alkyl esters were synthesized from starting materials that were purchased commercially and used without further purification.

General Procedure

To a dry 2000 mL round bottom flask containing a stir bar was added, using a funnel, 300 g of a fatty acid and 2 equivalents of an alkanol, followed by addition of 500 mL toluene. Stirring was started, and 0.005 equivalents (relative to fatty acid) of p-toluenesulfonic acid monohydrate was added. Toluene was used to wash down any material that adhered to the funnel or flask, and then toluene was added to bring the volume to 1500 mL. A Dean-Stark trap was attached to the flask along with a reflux condenser. The flask was heated to reflux, and the reaction was monitored by the evolution of water that was collected in the trap. After 24 hours, the reaction was cooled, and 80 mL of activated (grade 1) basic alumina was added and stirred for 5 minutes. The mixture was then filtered through a 300 mL frit charged with Celite 545 and a 1 cm layer of additional activated alumina to remove the acid catalyst. The majority of the solvent was removed by rotary evaporation, and residual solvent was removed by stirring under high vacuum (<100 microns) with a liquid nitrogen trap. NMR analysis indicated a single product that matches the intended alkyl ester.

Alternatively, the condensed vapor faction that distilled over was dried using molecular sieves to drive the reaction. This could help to avoid unfavorable azeotropes and to drive the reaction forward.

Characterization

Propyl palmitate: ¹H NMR (600 MHz, CDCl₃) δ 3.99 (t, J=6.6 Hz, 2H), 2.25 (t, J=7.6 Hz, 2H), 1.65-1.54 (m, 4H), 1.31-1.17 (m, 26H), 0.90 (t, J=7.4 Hz, 3H), 0.84 (t, J=6.8 Hz, 3H). ¹³C NMR (151 MHz, CDCl₃) δ 173.76, 77.22, 77.01, 76.79, 65.67, 34.28, 31.88, 29.65, 29.63, 29.61, 29.60, 29.55, 29.42, 29.32, 29.22, 29.12, 24.97, 22.63, 21.97, 14.00, 10.29.

Propyl stearate: ¹H NMR (600 MHz, CDCl₃) δ 4.02 (t, J=6.7 Hz, 2H), 2.29 (t, J=7.6 Hz, 2H), 1.63 (tq, J=14.5, 7.2 Hz, 4H), 1.33-1.19 (m, 30H), 0.94 (t, J=7.4 Hz, 3H), 0.87 (t, J=7.0 Hz, 3H). ¹³C NMR (151 MHz, CDCl₃) δ 173.67, 65.63, 34.26, 31.88, 29.66, 29.62, 29.60, 29.55, 29.42, 29.32, 29.23, 29.12, 24.96, 22.63, 21.96, 13.99, 10.27. GC-MS: [(M⁺)] C₂₁H₄₂O₂ Found 326.6; Calc 326.3.

Butyl stearate: ¹H NMR (600 MHz, CDCl₃) δ 4.05 (t, J=6.7 Hz, 2H), 2.27 (t, J=7.5 Hz, 2H), 1.64-1.56 (m, 4H), 1.37 (dt, J=15.0, 7.5 Hz, 2H), 1.32-1.20 (m, 30H), 0.92 (t, J=7.4 Hz, 3H), 0.87 (t, J=7.0 Hz, 3H). ¹³C NMR (151 MHz, CDCl₃) δ 173.92, 77.20, 76.99, 76.78, 64.03, 34.37, 31.91, 30.70, 29.67, 29.62, 29.57, 29.57, 29.45, 29.34, 29.24, 29.14, 25.00, 22.66, 19.12, 14.06, 13.66. GC-MS: [(M⁺)] C₂₂H₄₄O₂ Found 340.6; Calc 340.3.

Pentyl stearate: ¹H NMR (600 MHz, CDCl₃) δ 4.01 (t, J=6.7 Hz, 2H), 2.24 (t, J=7.5 Hz, 2H), 1.57 (qt, J=7.8, 4.7 Hz, 4H), 1.35-1.18 (m, 33H), 0.89-0.85 (m, 3H), 0.84 (t, J=6.9 Hz, 3H). ¹³C NMR (151 MHz, CDCl₃) δ 173.68, 77.22, 77.01, 76.80, 64.19, 34.28, 31.89, 29.66, 29.63, 29.62, 29.56, 29.43, 29.43, 29.33, 29.24, 29.12, 28.33, 28.05, 24.96, 22.63, 22.26, 13.99, 13.84. GC-MS: [(M⁺)] C₂₃H₄₆O₂ Found 354.6; Calc 354.3.

Hexyl stearate: ¹H NMR (600 MHz, CDCl₃) δ 4.02 (t, J=6.7 Hz, 2H), 2.24 (t, J=7.6 Hz, 2H), 1.58 (p, J=6.9 Hz, 4H), 1.36-1.17 (m, 35H), 0.85 (q, J=7.0 Hz, 6H). ¹³C NMR (151 MHz, CDCl₃) δ 173.67, 65.63, 34.26, 31.88, 29.66, 29.62, 29.60, 29.55, 29.42, 29.32, 29.23, 29.12, 24.96, 22.63, 21.96, 13.99, 10.27. GC-MS: [(M⁺)] C₂₄H₄₈O₂ Found 368.6; Calc 368.4.

Propyl behenate: ¹H NMR (600 MHz, CDCl₃) δ 4.01 (t, J=6.7 Hz, 2H), 2.27 (t, J=7.6 Hz, 2H), 1.67-1.56 (m, 4H), 1.35-1.17 (m, 39H), 0.92 (t, J=7.5 Hz, 3H), 0.86 (t, J=6.8 Hz, 3H). ¹³C NMR (151 MHz, CDCl₃) δ 173.84, 77.21, 76.99, 76.78, 65.72, 34.33, 31.91, 29.68, 29.66, 29.62, 29.58, 29.45, 29.35, 29.25, 29.14, 24.99, 22.66, 21.99, 14.05, 10.33. GC-MS: [(M⁺)] C₂₅H₅₀O₂ Found 382.4; Calc 382.4.

Preparation of Mixtures

Deionized water heated to greater than 85° C. was added to a Vitamix blender (model 5010). While on setting 1, the appropriate amount of coating agent was added slowly to the blender. The blender was capped and the mixture blended on ‘high’ for 3 minutes, then poured in 1 L Schott bottles and stored until use.

### Example 2. Coated Citrus

Coating agents A and B having the compositions shown in Table 1 were prepared.

TABLE 1
Coating Agent Compositions

| | A | | B | | C | | D | |
|---|---|---|---|---|---|---|---|---|
| Glyceryl Monostearate* | 95 | wt % | 92 | wt % | 95 | wt % | 92 | wt % |
| Sodium Stearate | 5 | wt % | 5 | wt % | 2 | wt % | 2 | wt % |

| | | | | | | |
|---|---|---|---|---|---|---|
| Sodium Palmitate | — | — | 3 | wt % | 3 | wt % |

| | | | | | | |
|---|---|---|---|---|---|---|
| Ethyl Palmitate | — | 3 | wt % | — | 3 | wt % |

*mixture of 2,3-dihydroxypropan-1-yl octadecanoate and 1,3-dihydroxypropan-2-yl octadecanoate (molar ratio of about 85:15 to about 95:5)

Mixtures 1, 2, 3, and 4 of coating agents A, B, C, and D dispersed in water at the concentrations shown in Table 2 were prepared. Each mixture was prepared by adding 40 g of coating agent to 1 L of water at 80° C., and then homogenizing in a blender for 3 minutes. For each of mixtures 1 and 2, groups of 120 waxed limes of the same size, quality, ripeness, pack date, and orchard were coated by dipping each lime into a bowl of the mixture and then drying in a rolling, translating heat tunnel at 65-70° C. for 100 seconds. For each of mixtures 3 and 4, groups of 120 unwaxed mandarins of the same size, quality, ripeness, pack date, and orchard were coated by dipping each mandarin or lime into a bowl of the mixture and then drying in a rolling, translating heat tunnel at 65-70° C. for 100 seconds. Mass loss of the coated mandarins and limes, and comparative groups of uncoated mandarins and limes were then measured. Results are shown in Table 2.

TABLE 2
Mixture Compositions; Mass Loss of Mandarins and Limes

| | | | Mass Loss | Mass Loss |
|---|---|---|---|---|
| | Coating | | Factor* | Factor* |
| | Agent | Concentration | (Mandarins) | (Limes) |
| Mixture 1 | A | 40 g/L | | 1.66 |
| Mixture 2 | B | 40 g/L | | 1.84 |
| Mixture 3 | C | 40 g/L | 2.76 | |
| Mixture 4 | D | 40 g/L | 3.21 | |
| Untreated | — | — | 1 | 1 |

*ratio of the average mass loss rate of untreated control to the average mass loss rate of corresponding tested produce for a given period of time

As shown in Table 2, coatings formed from coating agents including an alkyl ester of a fatty acid better reduced mass loss from produce than coatings lacking the alkyl ester.

### Example 3. Coated Avocados

Coating agents C-F having the compositions shown in Table 3 were prepared.

TABLE 3
Coating Agent Compositions

| | C | | D | | E | | F | |
|---|---|---|---|---|---|---|---|---|
| Glyceryl Monostearate | 90 | wt % | 90 | wt % | 90 | wt % | 90 | wt % |
| Sodium Stearate | 5 | wt % | 5 | wt % | 5 | wt % | 5 | wt % |

| | | | | | |
|---|---|---|---|---|---|
| Ethyl Laurate | 5 | wt % | — | — | — |

| | | | | | |
|---|---|---|---|---|---|
| Ethyl Myristate | — | 5 | wt % | — | — |

| | | | | | |
|---|---|---|---|---|---|
| Ethyl Palmitate | — | — | 5 | wt % | — |

| | | | | | |
|---|---|---|---|---|---|
| Ethyl Stearate | — | — | — | 5 | wt % |

Mixtures 3-7 of coating agents A and C-F dispersed in water at the concentrations shown in Table 4 were prepared. For each of mixtures 3-7, groups of 120 Mexican Hass avocados of the same size, quality, ripeness, pack date, and orchard were coated by dipping each avocado into a bowl of the mixture and then drying in a rolling, translating heat tunnel at 65-70° C. for 100 seconds. Mass loss and CO₂ respiration of the coated avocados and a comparative group of uncoated avocados was then measured. Results are shown in Table 4.

TABLE 4
Mixture Compositions; Mass Loss
and CO₂ Respiration of Avocados

| | Coating | | Mass Loss | Respiration |
|---|---|---|---|---|
| | Agent | Concentration | Factor | Factor* |
| Mixture 3 | A | 30 g/L | 1.52 | 1.32 |
| Mixture 4 | C | 30 g/L | 1.65 | 1.37 |
| Mixture 5 | D | 30 g/L | 1.63 | 1.37 |
| Mixture 6 | E | 30 g/L | 1.72 | 1.36 |
| Mixture 7 | F | 30 g/L | 1.68 | 1.31 |
| Untreated | — | — | 1 | 1 |

*ratio of the average CO₂ respiration rate (day of peak) of untreated control to the average CO₂ respiration rate (day of peak) of corresponding tested produce

As shown in Table 4, coatings formed from coating agents including an ethyl ester of a C₁₂-C₁₈ fatty acid reduced mass loss and respiration from produce.

### Example 4. Coated Avocados

Coating agents G-J having the compositions shown in Table 5 were prepared.

TABLE 5
Coating Agent Compositions

| | G | | H | | I | | J | |
|---|---|---|---|---|---|---|---|---|
| Glyceryl | 71.25 | wt % | 63.33 | wt % | 23.75 | wt % | — | |
| Monostearate | | | | | | | | |
| Sodium Stearate | 5 | wt % | 5 | wt % | 5 | wt % | 5 | wt % |
| Ethyl Palmitate | 23.75 | wt % | 31.67 | wt % | 71.25 | wt % | 95 | wt % |

Mixtures 8-12 of coating agents A and C-F dispersed in water at the concentrations shown in Table 6 were prepared. For each of mixtures 8-12, groups of 120 Mexican Hass avocados of the same size, quality, ripeness, pack date, and orchard were coated by dipping each avocado into a bowl of the mixture and then drying in a rolling, translating heat tunnel at 65-70° C. for 100 seconds. Mass loss and respiration of the coated avocados and a comparative group of uncoated avocados was then measured. Results are shown in Table 6.

TABLE 6
Mixture Compositions; Mass Loss and Respiration of Avocados

| | Coating | | Mass Loss | Respiration |
|---|---|---|---|---|
| | Agent | Concentration | Factor | Factor |
| Mixture 8 | A | 30 g/L | 1.20 | 1.06 |
| Mixture 9 | G | 30 g/L | 1.38 | 1.09 |
| Mixture 10 | H | 30 g/L | 1.43 | 1.12 |
| Mixture 11 | I | 30 g/L | 1.21 | 1.14 |
| Mixture 12 | J | 30 g/L | 1.11 | 1.11 |
| Untreated | — | — | 1 | 1 |

As shown in Table 6, coatings formed from coating agents including an alkyl ester and a monoglyceride in a weight ratio of 1:3-3:1 reduced mass loss and respiration from produce.

### Example 5. Coated Avocados

Mixtures 13-18 of coating agents A and G dispersed in water at the concentrations shown in Table 7 were prepared. For each of mixtures 13-18, groups of 120 Californian Hass avocados of the same size, quality, ripeness, pack date, and orchard were coated by dipping each avocado into a bowl of the mixture and then drying in a rolling, translating heat tunnel at 65-70° C. for 100 seconds. Mass loss and respiration of the coated avocados and a comparative group of uncoated avocados was then measured. Results are shown in Table 7.

TABLE 7
Mass Loss and Respiration of Avocados

| | Coating | | Mass Loss | Respiration |
|---|---|---|---|---|
| | Agent | Concentration | Factor | Factor |
| Mixture 13 | A | 10 g/L | 1.26 | 1.06 |
| Mixture 14 | G | 10 g/L | 1.38 | 1.05 |
| Mixture 15 | A | 30 g/L | 1.61 | 1.15 |
| Mixture 16 | G | 30 g/L | 1.80 | 1.22 |
| Mixture 17 | A | 50 g/L | 1.86 | 1.21 |
| Mixture 18 | G | 50 g/L | 2.08 | 1.30 |
| Untreated | — | — | 1 | 1 |

As shown in Table 7, for applications at concentrations ranging from 10 g/L to 50 g/L, coatings formed from coating agents including an alkyl ester better reduced mass loss and respiration from produce than corresponding coatings lacking the alkyl ester.

### Example 6. Morphological Characterization

Films 1-3 of coating agents A, G, and J, as shown in Table 8, were prepared. About 20 uL of each coating agent dispersed in water was drop-casted on a plastic substrate and dried at 70° C. for approximately 10 minutes.

TABLE 8
Mixture Compositions

| Film | Coating Agent |
|---|---|
| 1 | A |
| 2 | G |
| 3 | J |

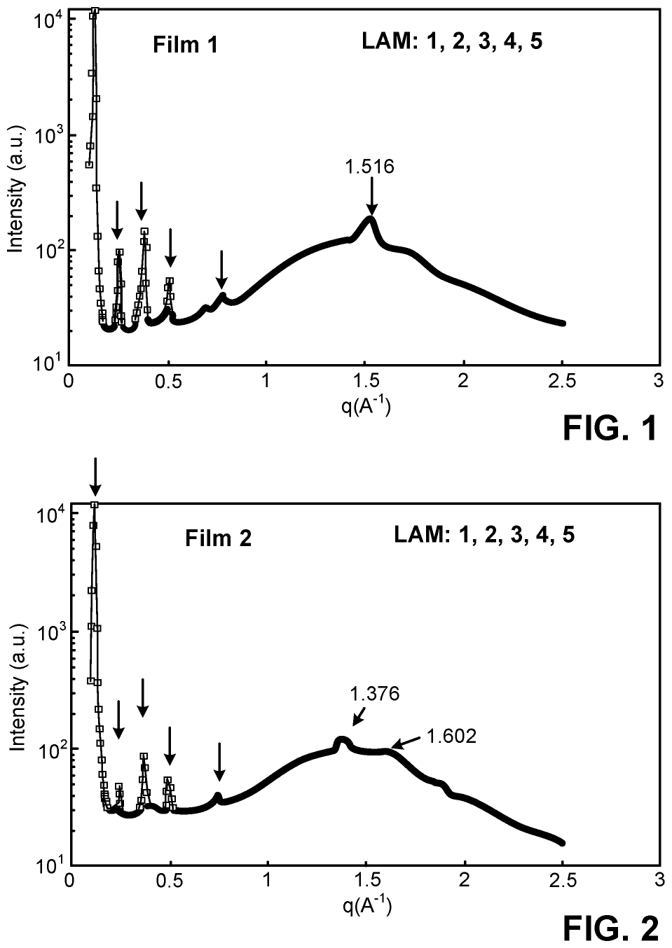

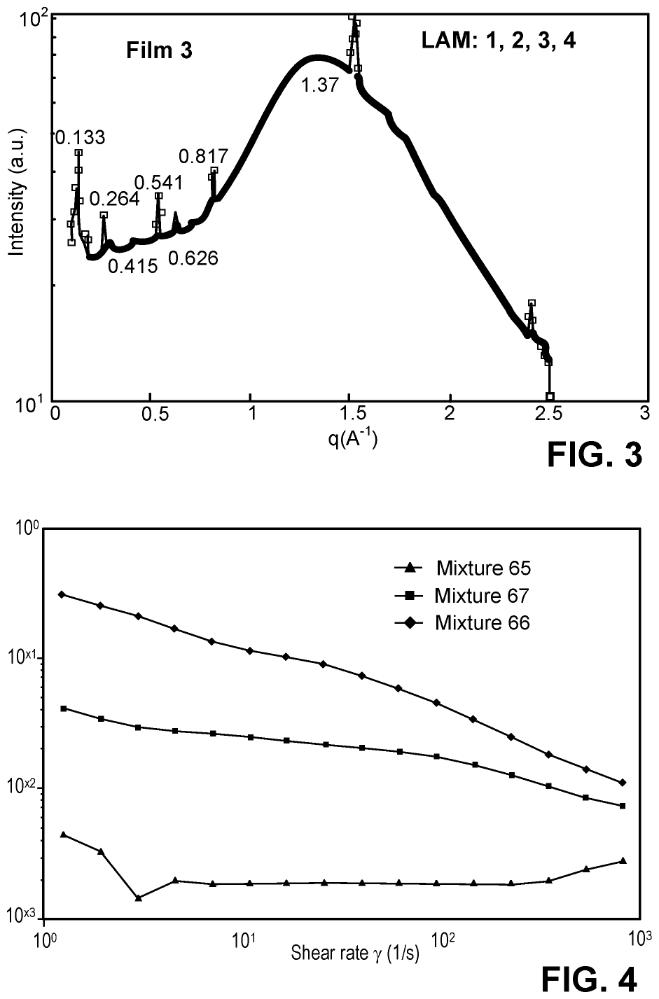

Films 1-3 were analyzed via small-angle X-ray scattering (SAXS) and wide-angle X-ray scattering (WAXS); the results are shown in FIGS. 1-3. The SAXS data, which provides information regarding long-range order, showed that each of films 1-3 exhibited Bragg reflections indicative of a lamellar mesophase. The WAXS data, which provides information regarding short-range order, showed that film 2 exhibited chain-packing characteristics of both the ethyl palmitate (q=1.37 Å⁻¹) and fatty acyl chains of the monoglyceride (q=1.60 Å⁻¹) components within the film.

### Example 7. Mixture Characterization, Coated Avocados

Coating agents K-AH having the compositions shown in Tables 9-14 were prepared.

TABLE 9
Coating Agent Compositions

| | K | | L | | M | | N | |
|---|---|---|---|---|---|---|---|---|
| Glyceryl | 71.25 | wt % | 47.5 | wt % | 23.75 | wt % | 0 | wt % |
| Monostearate | | | | | | | | |
| Sodium Stearate | 5 | wt % | 5 | wt % | 5 | wt % | 5 | wt % |
| Methyl Stearate | 23.75 | wt % | 47.5 | wt % | 71.25 | wt % | 100 | wt % |

TABLE 10
Coating Agent Compositions

| | O | | P | | Q | | R | |
|---|---|---|---|---|---|---|---|---|
| Glyceryl | 71.25 | wt % | 47.5 | wt % | 23.75 | wt % | 0 | wt % |
| Monostearate | | | | | | | | |
| Sodium Stearate | 5 | wt % | 5 | wt % | 5 | wt % | 5 | wt % |
| Ethyl Stearate | 23.75 | wt % | 47.5 | wt % | 71.25 | wt % | 100 | wt % |

TABLE 11
Coating Agent Compositions

| | S | | T | | U | | V | |
|---|---|---|---|---|---|---|---|---|
| Glyceryl | 71.25 | wt % | 47.5 | wt % | 23.75 | wt % | 0 | wt % |
| Monostearate | | | | | | | | |
| Sodium Stearate | 5 | wt % | 5 | wt % | 5 | wt % | 5 | wt % |
| Propyl Stearate | 23.75 | wt % | 47.5 | wt % | 71.25 | wt % | 100 | wt % |

TABLE 12
Coating Agent Compositions

| | W | | X | | Y | | Z | |
|---|---|---|---|---|---|---|---|---|
| Glyceryl | 71.25 | wt % | 47.5 | wt % | 23.75 | wt % | 0 | wt % |
| Monostearate | | | | | | | | |
| Sodium Stearate | 5 | wt % | 5 | wt % | 5 | wt % | 5 | wt % |
| Isopropyl Stearate | 23.75 | wt % | 47.5 | wt % | 71.25 | wt % | 100 | wt % |

TABLE 13
Coating Agent Compositions

| | AA | | AB | | AC | | AD | |
|---|---|---|---|---|---|---|---|---|
| Glyceryl | 71.25 | wt % | 47.5 | wt % | 23.75 | wt % | 0 | wt % |
| Monostearate | | | | | | | | |
| Sodium Stearate | 5 | wt % | 5 | wt % | 5 | wt % | 5 | wt % |
| Butyl Stearate | 23.75 | wt % | 47.5 | wt % | 71.25 | wt % | 100 | wt % |

TABLE 14
Coating Agent Compositions

| | AE | | AF | | AG | | AH | |
|---|---|---|---|---|---|---|---|---|
| Glyceryl | 71.25 | wt % | 47.5 | wt % | 23.75 | wt % | 0 | wt % |
| Monostearate | | | | | | | | |
| Sodium Stearate | 5 | wt % | 5 | wt % | 5 | wt % | 5 | wt % |
| Isoamyl Stearate | 23.75 | wt % | 47.5 | wt % | 71.25 | wt % | 100 | wt % |

Mixtures 19-48 of coating agents A and K-AH dispersed in water (25 g/L), as shown in Tables 15-20, were prepared. The mixtures were evaluated for foaming upon mixing, and then a portion of each mixture was set aside for daily evaluation of stability.

For each of mixtures 19-48, within 24 hours of preparation, groups of 60 Mexican Hass avocados of the same size, quality, ripeness, pack date, and orchard were coated by dipping each avocado into a bowl of the mixture and then drying in a rolling, translating heat tunnel at 70° C. with a residence time of 100 seconds. Avocados were removed from cold storage 30 minutes prior to treatment. The coatings were evaluated before and after drying. Mass loss and respiration of the coated avocados and a comparative group of uncoated avocados (“UT”) was then measured. Results are shown in Tables 15-20.

TABLE 15
Mixture Properties; Mass Loss and
Respiration Factors of Avocados

| | | Foam | | | | MLF/ | MLF²/ |
|---|---|---|---|---|---|---|---|
| Mixt. | Agent | on Mix. | Residue | MLF* | RF** | RF^{†} | RF^{††} |
| 19 | A | No | No | 1.34 | 1.09 | 1.00 | 1.00 |
| 20 | K | No | No | 1.50 | 1.06 | 1.14 | 1.29 |
| 21 | L | No | No | 1.56 | 1.12 | 1.13 | 1.32 |
| 22 | M | No | No | 1.35 | 1.09 | 1.01 | 1.01 |
| 23 | N | Yes | Yes | 1.15 | 1.07 | 0.87 | 0.75 |
| UT | — | — | — | 1 | 1 | — | — |

*Mass Loss Factor (MLF)
**Respiration Factor (RF)
^{†}MLF/RF, normalized to mixture 19
^{††}MLF²/RF, normalized to mixture 19

TABLE 16
Mixture Properties; Mass Loss and
Respiration Factors of Avocados

| | | Foam | | | | MLF/ | MLF²/ |
|---|---|---|---|---|---|---|---|
| Mixt. | Agent | on Mix. | Residue | MLF | RF | RF^{†} | RF^{††} |
| 24 | A | No | No | 1.34 | 1.09 | 1.00 | 1.00 |
| 25 | O | No | No | 1.80 | 1.22 | 1.20 | 1.61 |
| 26 | P | No | No | 1.65 | 1.29 | 1.04 | 1.28 |
| 27 | Q | No | No | 1.39 | 1.12 | 1.01 | 1.05 |
| 28 | R | Yes | Yes | 1.20 | 1.09 | 0.89 | 0.80 |
| UT | — | — | — | 1 | 1 | — | |

^{†}MLF/RF, normalized to mixture 24
^{††}MLF²/RF, normalized to mixture 24

TABLE 17
Mixture Properties; Mass Loss and
Respiration Factors of Avocados

| | | Foam | | | | MLF/ | MLF²/ |
|---|---|---|---|---|---|---|---|
| Mixt. | Agent | on Mix. | Residue | MLF | RF | RF^{†} | RF^{††} |
| 29 | A | No | No | 1.40 | 1.18 | 1.00 | 1.00 |
| 30 | S | No | No | 2.51 | 1.60 | 1.13 | 2.37 |
| 31 | T | No | No | 1.63 | 1.25 | 1.10 | 1.28 |
| 32 | U | No | No | 1.44 | 1.20 | 1.02 | 1.04 |
| 33 | V | Yes | Yes | 1.24 | 1.11 | 0.94 | 0.83 |
| UT | — | — | — | 1 | 1 | — | — |

^{†}MLF/RF, normalized to mixture 29
^{††}MLF²/RF, normalized to mixture 29

TABLE 18
Mixture Properties; Mass Loss and
Respiration Factors of Avocados

| | | Foam | | | | MLF/ | MLF²/ |
|---|---|---|---|---|---|---|---|
| Mixt. | Agent | on Mix. | Residue | MLF | RF | RF^{†} | RF^{††} |
| 34 | A | No | No | 1.40 | 1.18 | 1.00 | 1.00 |
| 35 | W | No | No | 1.81 | 1.28 | 1.20 | 1.54 |
| 36 | X | No | No | 1.60 | 1.18 | 1.14 | 1.31 |
| 37 | Y | No | No | 1.44 | 1.17 | 1.04 | 1.07 |
| 38 | Z | Yes | No | 1.31 | 1.15 | 0.96 | 0.90 |
| UT | — | — | — | 1 | 1 | — | — |

^{†}MLF/RF, normalized to mixture 34
^{††}MLF²/RF, normalized to mixture 34

TABLE 19
Mixture Properties; Mass Loss and
Respiration Factors of Avocados

| | | Foam | | | | MLF/ | MLF²/ |
|---|---|---|---|---|---|---|---|
| Mixt. | Agent | on Mix. | Residue | MLF | RF | RF^{†} | RF^{††} |
| 39 | A | No | No | 1.68 | 1.18 | 1.00 | 1.00 |
| 40 | AA | No | No | 1.61 | 1.09 | 1.04 | 0.99 |
| 41 | AB | No | No | 1.63 | 1.15 | 1.00 | 0.97 |
| 42 | AC | No | No | 1.63 | 1.15 | 0.99 | 0.97 |
| 43 | AD | Yes | No | 1.42 | 1.13 | 0.89 | 0.75 |
| UT | — | — | — | 1 | 1 | — | — |

^{†}MLF/RF, normalized to mixture 39
^{††}MLF²/RF, normalized to mixture 39

TABLE 20
Mixture Properties; Mass Loss and
Respiration Factors of Avocados

| | | Foam | | | | MLF/ | MLF²/ |
|---|---|---|---|---|---|---|---|
| Mixt. | Agent | on Mixing | Residue | MLF | RF | RF^{†} | RF^{††} |
| 44 | A | No | No | 1.68 | 1.18 | 1.00 | 1.00 |
| 45 | AE | No | No | 1.75 | 1.15 | 1.07 | 1.11 |
| 46 | AF | No | No | 1.81 | 1.26 | 1.01 | 1.09 |
| 47 | AG | No | No | 1.70 | 1.18 | 1.02 | 1.02 |
| 48 | AH | Yes | No | 1.29 | 1.11 | 0.81 | 0.63 |
| UT | — | — | — | 1 | 1 | — | — |

^{†}MLF/RF, normalized to mixture 44
^{††}MLF²/RF, normalized to mixture 44

As shown in Tables 15-20, stability decreased as the number of alkyl carbons increased, and as the amount of alkyl ester increased. Increased amounts of alkyl esters also increased opacity. Stability became more difficult to determine for mixtures including more than 50 wt % alkyl ester, due to increased opacity. It was observed visually that the viscosity of the coated mixtures increased as the amount of alkyl ester increased, from apparently about 1-2 cP to about 5 cP. The viscosity of mixture 30 appeared to increase to about 100 cP upon contact with the cold fruit.

As shown in Tables 15-20, inclusion of up to 50 wt % of an alkyl ester selectively increased the mass-barrier performance relative to the respiration barrier performance of the coating (MLF/RF>1). In Tables 15-20, increased MLF²/RF values indicated particularly high-performing coatings.

### Example 8. Coated Limes

Coating agents AI-AM having the compositions shown in Table 21 were prepared.

TABLE 21
Coating Agent Compositions

| | AI | | AJ | | AK | | AL | | AM | |
|---|---|---|---|---|---|---|---|---|---|---|
| Glyceryl | 88.35 | wt % | 80.75 | wt % | 61.75 | wt % | 67.5 | wt % | 63.75 | wt % |
| Monostearate | | | | | | | | | | |
| Sodium Stearate | 5 | wt % | 5 | wt % | 5 | wt % | 10 | wt % | 15 | wt % |
| Propyl Stearate | 6.65 | wt % | 14.25 | wt % | 33.25 | wt % | 22.5 | wt % | 21.25 | wt % |

Mixtures 49-64 of coating agents A, S, and AI-AM dispersed in water at the concentrations shown in Tables 22-24 were prepared. For each of mixtures 49-64, groups of 120 unwaxed Persian limes of the same size, quality, ripeness, pack date, and orchard were coated by dipping each lime into a bowl of the mixture and then drying in a rolling, translating heat tunnel at 70° C. at a drive speed of 10 Hz (residence time ˜120 seconds). Limes were removed from cold storage one hour prior to treatment. Mass loss and respiration of the coated limes and a comparative group of uncoated limes was then measured. Results are shown in Tables 22-24.

TABLE 22
Mixture Compositions; Mass Loss of Limes

| | Coating Agent | Concentration | Mass Loss Factor* |
|---|---|---|---|
| Mixture 49 | A | 25 g/L | 1.35 |
| Mixture 50 | A | 50 g/L | 1.39 |
| Mixture 51 | AI | 25 g/L | 1.82 |
| Mixture 52 | AJ | 25 g/L | 2.06 |
| Mixture 53 | S | 25 g/L | 2.14 |
| Mixture 54 | AK | 25 g/L | 2.37 |
| Untreated | — | — | 1 |

*Superscript indicates statistically different groups (α = 0.05)

TABLE 23
Mixture Compositions; Mass Loss of Limes

| | Coating Agent | Concentration | Mass Loss Factor |
|---|---|---|---|
| Mixture 55 | A | 25 g/L | 1.35 |
| Mixture 56 | A | 50 g/L | 1.39 |
| Mixture 57 | S | 25 g/L | 2.14 |
| Mixture 58 | S | 35 g/L | 2.56 |
| Mixture 59 | S | 50 g/L | 2.65 |
| Untreated | — | — | 1 |

TABLE 24
Mixture Compositions; Mass Loss of Limes

| | Coating Agent | Concentration | Mass Loss Factor |
|---|---|---|---|
| Mixture 60 | A | 25 g/L | 1.35 |
| Mixture 61 | A | 50 g/L | 1.39 |
| Mixture 62 | AM | 25 g/L | 1.50 |
| Mixture 63 | AL | 25 g/L | 1.60 |
| Mixture 64 | AK | 25 g/L | 2.14 |
| Untreated | — | — | 1 |

As shown in Table 22, coatings formed from coating agents including increased propyl stearate better reduced mass loss. As shown in Table 23, coatings formed from mixtures including increased concentrations of coating agent better reduced mass loss. As shown in Table 24, coatings formed from coating agents including 5 wt % sodium stearate better reduced mass loss relative to those including 10 wt % or more sodium stearate.

### Example 9. Differential Scanning Calorimetry, Viscometry

Mixtures 65-67 of coating agents A, S, and O dispersed in water at the concentrations shown in Table 25 were prepared. Samples of propyl stearate and mixtures 65 and 66 were loaded into A1 hermetic sealing pans and cycled from 10° C. to 90° C. at 10° C./min ramp rates on a differential scanning calorimeter. The second cycle was analyzed. Viscosity of mixtures 65-67 was also determined across a shear range of 2×10⁻¹ Pa·s. Results are shown in FIG. 4

TABLE 25
Mixture Compositions; Mass Loss of Limes

| | Coating Agent | Concentration |
|---|---|---|
| Mixture 65 | A | 25 g/L |
| Mixture 66 | S | 25 g/L |
| Mixture 67 | O | 25 g/L |

The differential scanning calorimetry (DSC) results showed a melting transition of propyl stearate around 29.8° C., crystallization at 24.8° C., and a phase transition at 18° C. A liquid crystal transition was observed for mixture 65 at 58.6° C. on the heating cycle (enthalpy of transition 1.64 J/g). For mixture 66, a liquid crystal transition was observed at 56.9° C. on the heating cycle (enthalpy of transition 1.30 J/g). No evidence of pure domains of propyl stearate was observed. Without wishing to be bound by theory, the results indicated that propyl stearate was incorporated in a disordered fashion into glyceryl monostearate-dominated vesicles.

As shown in FIG. 4, the viscosity of mixture 65 was constant across the shear range tested, while mixtures 66 and 67 showed shear thinning at about 2×10⁻² to 3×10⁻¹ Pa·s and 2-4×10⁻² Pa·s, respectively. The results indicate that propyl stearate and ethyl stearate acted as a viscosity modifier that could provide improved films in the low-shear regime.

### Example 10. Coated Apples

Coating agents AN-AP having the compositions shown in Table 26 were prepared.

TABLE 26
Coating Agent Compositions

| | AN | | AO | | AP | |
|---|---|---|---|---|---|---|
| Glyceryl Monostearate | 90.25 | wt % | 67.69 | wt % | 67.69 | wt % |
| Sodium Stearate | 4.75 | wt % | 4.75 | wt % | 4.75 | wt % |
| Ethyl Stearate | — | | 22.56 | wt % | — | |
| Propyl Stearate | — | | — | | 22.56 | wt % |
| Glyceryl Monolaurate* | 5 | wt % | 5 | wt % | 5 | wt % |

*mixture of 2,3-dihydroxypropan-1-yl dodecanoate and 1,3-dihydroxypropan-2-yl dodecanoate (molar ratio of about 90:10)

Mixtures 68-73 of coating agents A, O, S, and AN-AP dispersed in water at the concentrations shown in Table 27 were prepared. For each of mixtures 68-73, groups of apples of the same size, quality, ripeness, pack date, and orchard were coated by dipping each apple into a bowl of the mixture and then drying in a rolling, translating heat tunnel at 65-70° C. for 100 seconds. Mass loss of the coated apple and a comparative group of uncoated apples was then measured. Results are shown in Table 27.

TABLE 27
Mass Loss of Apples; Coating Efficiency

| | Coating | | Mass Loss | |
|---|---|---|---|---|
| | Agent | Concentration | Factor* | Efficiency^{†} |
| Mixture 68 | A | 50 g/L | 1.65 | 1.00 |
| Mixture 69 | AN | 50 g/L | 1.83 | 0.91 |
| Mixture 70 | O | 50 g/L | 2.02 | 0.82 |
| Mixture 71 | AO | 50 g/L | 2.10 | 1.05 |
| Mixture 72 | S | 50 g/L | 2.26 | 0.98 |
| Mixture 73 | AP | 50 g/L | 2.89 | 0.86 |
| Untreated | — | — | 1 | — |

^{†}Ratio of the mass of coating agent in grams to the product of the mass loss factor and the mass of produce in kg (lower is better)

As shown in Table 27, coatings formed from coating agents including glyceryl monolaurate demonstrated better performance compared to those lacking glyceryl monolaurate. As shown in Table 27, efficiency was better for coating agents including propyl stearate, as compared to those including ethyl stearate.

### Example 11. Coated Avocados

Coating agents AQ and AR having the compositions shown in Table 28 were prepared.

TABLE 28
Coating Agent Compositions

| | AQ | AR |
|---|---|---|
| Glyceryl Monostearate | 80 wt % | 60 wt % |
| Sodium Stearate | 20 wt % | 20 wt % |
| Propyl Stearate | — | 20 wt % |

Mixtures 74-85 of coating agents A, S, AQ, and AR dispersed in water at the concentrations shown in Table 29 were prepared. For each of mixtures 74-85, within 24 hours of preparation, groups of 60 Mexican Hass avocados of the same size, quality, ripeness, pack date, and orchard were coated by dipping each avocado into a bowl of the mixture and then drying in a rolling, translating heat tunnel at 70° C. with a residence time of 100 seconds. Avocados were removed from cold storage 30 minutes prior to treatment. Mass loss and respiration of the coated avocados and a comparative group of uncoated avocados (UT) was then measured. Results are shown in Table 29.

TABLE 29
Mixture Compositions; Mass Loss and
Respiration Factors of Avocados

| | Coating | | | | MLF/ | MLF²/ |
|---|---|---|---|---|---|---|
| | Agent | Conc. | MLF | RF | RF^{†} | RF^{††} |
| Mixture 74 | A | 10 g/L | 1.08 | 0.94 | 1.00 | 1.00 |
| Mixture 75 | A | 20 g/L | 1.25 | 1.10 | 0.99 | 1.15 |
| Mixture 76 | A | 40 g/L | 1.56 | 1.09 | 1.25 | 1.81 |
| Mixture 77 | AQ | 10 g/L | 1.29 | 1.06 | 1.06 | 1.27 |
| Mixture 78 | AQ | 20 g/L | 1.47 | 1.10 | 1.16 | 1.60 |
| Mixture 79 | AQ | 40 g/L | 1.67 | 1.21 | 1.21 | 1.88 |
| Mixture 80 | S | 10 g/L | 1.43 | 1.05 | 1.18 | 1.58 |
| Mixture 81 | S | 20 g/L | 2.11 | 1.26 | 1.46 | 2.87 |
| Mixture 82 | S | 40 g/L | 3.00 | 2.16 | 1.21 | 3.38 |
| Mixture 83 | AR | 10 g/L | 1.50 | 1.04 | 1.26 | 1.75 |
| Mixture 84 | AR | 20 g/L | 1.62 | 1.12 | 1.26 | 1.89 |
| Mixture 85 | AR | 40 g/L | 1.94 | 1.22 | 1.38 | 2.49 |
| UT | — | — | 1 | 1 | — | — |

^{†}MLF/RF, normalized to mixture 74
^{††}MLF²/RF, normalized to mixture 74

As shown in Table 29, coatings formed from coating agents including propyl stearate, applied at 10-20 g/L, performed similarly or better than coatings formed from coating agents lacking propyl stearate, even when applied at 40 g/L.

Although this disclosure contains many specific embodiment details, these should not be construed as limitations on the scope of the subject matter or on the scope of what may be claimed, but rather as descriptions of features that may be specific to particular embodiments. Certain features that are described in this disclosure in the context of separate embodiments can also be implemented, in combination, in a single embodiment. Conversely, various features that are described in the context of a single embodiment can also be implemented in multiple embodiments, separately, or in any suitable sub-combination. Moreover, although previously described features may be described as acting in certain combinations and even initially claimed as such, one or more features from a claimed combination can, in some cases, be excised from the combination, and the claimed combination may be directed to a sub-combination or variation of a sub-combination.

Particular embodiments of the subject matter have been described. Other embodiments, alterations, and permutations of the described embodiments are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations may be considered optional), to achieve desirable results.

Accordingly, the previously described example embodiments do not define or constrain this disclosure. Other changes, substitutions, and alterations are also possible without departing from the spirit and scope of this disclosure.

1. A composition comprising:
one or more monoglycerides of a C₄-C₂₈ fatty acid, present in a total amount of about 15 wt % to about 99 wt % of the composition; and
one or more alkyl esters of a C₈-C₂₀ fatty acid, present in a total amount of about 1 wt % to about 75 wt % of the composition.

2. The composition of claim 1, wherein:
the one or more monoglycerides are present in a total amount of about 70 wt % to about 99 wt % of the composition; and
the one or more alkyl esters are present in a total amount of about 1 wt % to about 15 wt % of the composition.

3. The composition of claim 1, wherein:
the one or more monoglycerides are present in a total amount of about 15 wt % to about 85 wt % of the composition; and
the one or more alkyl esters are present in a total amount of about 15 wt % to about 75 wt % of the composition.

4. The composition of claim 1, further comprising one or more salts of a C₄-C₂₈ fatty acid, present in a total amount of 0.1 wt % to about 30 wt % of the composition.

5. A composition comprising:
one or more monoglycerides of a C₄-C₂₈ fatty acid; and
one or more alkyl esters of a C₈-C₂₀ fatty acid,
wherein a ratio of a total number of moles of the one or more monoglycerides to a total number of moles of the one or more alkyl esters is about 100:1 to about 1:5.

6. The composition of claim 5, wherein the ratio of the total number of moles of the one or more monoglycerides to the total number of moles of the one or more alkyl esters is about 50:1 to about 6:1.

7. The composition of claim 5, wherein the ratio of the total number of moles of the one or more monoglycerides to the total number of moles of the one or more alkyl esters is about 3:1 to about 1:3.

8. The composition of claim 5, further comprising one or more salts of a C₄-C₂₈ fatty acid.

9. The composition of claim 1, wherein the one or more alkyl esters each independently comprise a C₁-C₅ alkyl ester.

10. The composition of claim 1, wherein each of the one or more alkyl esters independently comprises a compound of Formula III: 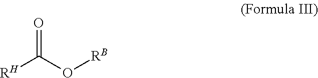
wherein:
R^{B} is C₁-C₈ alkyl; and
R^{H} is a C₇-C₁₉ side chain.

11. The composition of claim 1, wherein each of the one or more monoglycerides independently comprises a compound of Formula I-i or Formula I-ii: 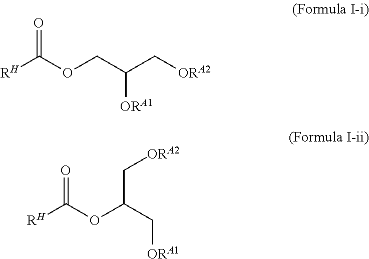
wherein:
R^{A1} and R^{A2} are each independently selected from H and C₁-C₆ alkyl; and
R^{H} is a C₃-C₂₇ side chain.

12. The composition of claim 1, wherein each of the one or more salts present in the composition independently comprises a compound of Formula II: 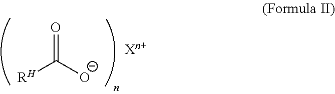
wherein:
R^{H} is a C₃-C₂₇ side chain; and
Xⁿ⁺ is a cationic moiety having formal charge n.

13. A mixture comprising:
the composition of claim 1; and
a solvent.

14. A coated agricultural product comprising an agricultural product and a layer disposed on a surface of the agricultural product, wherein the layer comprises the composition of claim 1.

15. A method of coating an agricultural product, the method comprising:
contacting a surface of the agricultural product with a mixture comprising a coating agent and a solvent, wherein the coating agent comprises:
one or more monoglycerides of a C₄-C₂₈ fatty acid; and
one or more alkyl esters of a C₈-C₂₀ fatty acid,
wherein a ratio of a total number of moles of the one or more monoglycerides to a total number of moles of the one or more alkyl esters is about 100:1 to about 1:5; and
removing at least a portion of the solvent to form a coating on the surface of the agricultural product.

16. The method of claim 15, further comprising adding the one or more alkyl esters of a C₈-C₂₀ fatty acid to a pre-mixture comprising the solvent and the one or more monoglycerides of a C₄-C₂₈ fatty acid to form the mixture.

17. The method of claim 15, wherein the ratio of the total number of moles of the one or more monoglycerides to the total number of moles of the one or more alkyl esters is about 50:1 to about 6:1.

18. The method of claim 15, wherein the ratio of the total number of moles of the one or more monoglycerides to the total number of moles of the one or more alkyl esters is about 3:1 to about 1:3.

19. The method of claim 15, wherein the one or more alkyl esters each independently comprise a C₁-C₅ alkyl ester.

20. The method of claim 15, wherein the coating agent further comprises one or more salts of a C₄-C₂₈ fatty acid, wherein a ratio of a total number of moles of the one or more monoglycerides and the one or more alkyl esters to a total number of moles of the one or more salts is about 100:1 to about 4:1.
